(19) United States
(12) Patent Application Publication
(10) Pub. No.: US 2016/0004425 A1
(43) Pub. Date: Jan. 7, 2016

(54) METHOD OF DISPLAYING GRAPHIC USER INTERFACE AND ELECTRONIC DEVICE IMPLEMENTING SAME

(71) Applicant: Samsung Electronics Co., Ltd., Suwon-si (KR)

(72) Inventors: Sungjin YOON, Suwon-si (KR); Jihyun KIM, Suwon-si (KR); Jihea PARK, Seoul (KR); Sejun SONG, Seongnam-si (KR); Hanjun KU, Suwon-si (KR); Chulhwan LEE, Seoul (KR); Pyoje CHO, Suwon-si (KR); Yoojin HONG, Seongnam-si (KR)

(21) Appl. No.: 14/791,837

(22) Filed: Jul. 6, 2015

(30) Foreign Application Priority Data
Jul. 7, 2014 (KR) 10-2014-0084810

(51) Int. Cl. G06F 3/0488; G06F 3/0484

(52) U.S. Cl. CPC G06F 3/04883; G06F 3/04847

(57) ABSTRACT

A method of displaying a graphic user interface (GUI) by an electronic device is provided. The method includes displaying a first page from a plurality of pages and the GUI corresponding to the first page on a screen, displaying at least a part of the first page and at least a part of a second page adjacent to the first page from the plurality of pages based on a user input received in at least one of an area in which the first page is displayed and an area in which the GUI is displayed, and changing the displayed GUI according to a ratio between an area of at least the part of the displayed first page and an area of at least the part of the displayed second page.

### CROSS-REFERENCE TO RELATED APPLICATION(S)

This application claims the benefit under 35 U.S.C. §119(a) of a Korean patent application filed on Jul. 7, 2014 in the Korean Intellectual Property Office and assigned Serial number 10-2014-0084810, the entire disclosure of which is hereby incorporated by reference.

### TECHNICAL FIELD

The present disclosure relates to an electronic device. More particularly, the present disclosure relates to a method of displaying a graphic user interface and an electronic device implementing the same.

### BACKGROUND

Based on development of information communication technologies and semiconductor technologies, the supply and use of various portable electronic devices have rapidly increased. Recent electronic devices have been developed to include various functions for users. For example, the electronic device provides a text message transmission/reception, photography, video reproduction, game, memo, calendar, or Internet function as well as a simple voice call function.

Meanwhile, the electronic device displays objects (for example, icons) to allow the user to conveniently execute the various functions. Further, as the number of objects displayed in the home screen or the menu screen increases, the electronic device includes a plurality of pages to display a plurality of objects. The electronic device displays a page indicator to distinguish between a plurality of pages. For example, the electronic device displays dots corresponding to the number of a plurality of pages and marks a dot corresponding to a page currently displayed in the screen with a different color from colors of other dots.

Further, the electronic device displays a plurality of objects (for example, items) in a list form through one long page and displays objects, which are not displayed on the screen, by a scrolling operation. In addition, the electronic device displays a scroll bar for indicating a location of an object displayed within a long page.

The above information is presented as background information only to assist with an understanding of the present disclosure. No determination has been made, and no assertion is made, as to whether any of the above might be applicable as prior art with regard to the present disclosure.

### SUMMARY

When a user switches a currently displayed page, the page indicator of the related art simply reflects only a result of the switching of the page. For example, when the switching is made from a currently displayed page to another page, a color of the displayed page is changed into a color of the switched page. Further, the scroll bar of the related art is a typical type, for example, a rectangular type, and thus may have difficulty in reflecting a state of a scrolled object in real time.

Aspects of the present disclosure are to address at least the above-mentioned problems and/or disadvantages and to provide at least the advantages described below. Accordingly, an aspect of the present disclosure is to provide a method of displaying an intuitive graphic user interface (GUI) by reflecting page switching or screen scrolling in real time, and an electronic device supporting the same.

In accordance with an aspect of the present disclosure, a method of displaying a GUI by an electronic device is provided. The method includes displaying a first page from a plurality of pages and the GUI corresponding to the first page on a screen, displaying at least a part of the first page and at least a part of a second page adjacent to the first page from the plurality of pages based on a user input received in at least one of an area in which the first page is displayed and an area in which the GUI is displayed, and changing the displayed GUI according to a ratio between an area of at least the part of the displayed first page and an area of at least the part of the displayed second page.

In accordance with another aspect of the present disclosure, a method of displaying a GUI by an electronic device is provided. The method includes displaying one or more of a plurality of objects and the GUI corresponding to the one or more objects on a screen, scrolling the one or more objects based on a user input received in at least one of an area in which the one or more objects are displayed and an area in which the GUI is displayed, and changing the GUI according to a scrolling distance of the one or more objects.

A method of displaying a GUI and an electronic device supporting the same according to various embodiments may reflect, for example, page switching or screen scrolling in real time, so as to provide an intuitive experience to a user.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an environment of a network including an electronic device according to various embodiments of the present disclosure;

FIG. 2 is a block diagram of a graphic user interface (GUI) display module according to various embodiments of the present disclosure;

FIG. 3 illustrates a flowchart for a method of displaying a GUI according to an embodiment of the present disclosure;

FIGS. 4A, 4B, 4C, and 4D illustrate an example for describing a method of displaying a GUI according to an embodiment of the present disclosure;

FIGS. 5A, 5B, 5C, and 5D illustrate an example for describing a method of displaying a GUI according to an embodiment of the present disclosure;

FIGS. 6A, 6B, 6C, 6D, 6E, 6F, 6G, and 6H illustrate examples for describing a method of displaying a GUI according to various embodiments of the present disclosure;

FIGS. 7A and 7B illustrate an example for describing a method of displaying a GUI according to an embodiment of the present disclosure;

FIGS. 8A, 8B, 8C, and 8D illustrate an example for describing a method of displaying a GUI according to an embodiment of the present disclosure;

FIGS. 9A, 9B, 9C, and 9D illustrate an example for describing a method of displaying a GUI according to an embodiment of the present disclosure;

FIGS. 10A, 10B, 10C, and 10D illustrate an example for describing a method of displaying a GUI according to an embodiment of the present disclosure;

FIGS. 11A, 11B, 11C, and 11D illustrate an example for describing a method of displaying a GUI according to an embodiment of the present disclosure;

FIGS. 12A, 12B, 12C, and 12D illustrate an example for describing a method of displaying a GUI according to an embodiment of the present disclosure;

FIGS. 13A, 13B, 13C, and 13D illustrate an example for describing a method of displaying a GUI according to an embodiment of the present disclosure;

FIGS. 14A, 14B, and 14C illustrate an example for describing a method of displaying a GUI according to an embodiment of the present disclosure;

FIGS. 15A, 15B, 15C, and 15D illustrate an example for describing a method of displaying a GUI according to an embodiment of the present disclosure;

FIG. 16 is a flowchart illustrating a method of displaying a GUI according to an embodiment of the present disclosure;

FIGS. 17A, 17B, and 17C illustrate an example for describing a method of displaying a GUI according to an embodiment of the present disclosure;

FIGS. 18A, 18B, 18C, and 18D illustrate an example for describing a method of displaying a GUI according to an embodiment of the present disclosure;

FIGS. 19A, 19B, 19C, and 19D illustrate an example for describing a method of displaying a GUI according to an embodiment of the present disclosure;

FIGS. 20A and 20B illustrate an example for describing a method of displaying a GUI according to an embodiment of the present disclosure;

FIGS. 21A, 21B, and 21C illustrate an example for describing a method of displaying a GUI according to an embodiment of the present disclosure;

FIGS. 22A, 22B, and 22C illustrate an example for describing a method of displaying a GUI according to an embodiment of the present disclosure;

FIGS. 23A, 23B, and 23C illustrate an example for describing a method of displaying a GUI according to an embodiment of the present disclosure;

FIG. 24 is a block diagram of an electronic device according to various embodiments of the present disclosure; and

FIG. 25 illustrates a communication protocol between a plurality of electronic devices according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to describing various embodiments of the present disclosure, a graphic user interface (GUI) may be defined as a term that collectively refers to a medium, which can work through a graphic when a user exchanges information with an electronic device.

The term “object” includes an icon, an item, a file, an image, and the like, and may be defined as including all of a picture or a symbol displayed on a screen of the electronic device to select a particular function or data, or a content indicated by data.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

In an embodiment of the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween. The terms used in the present disclosure are only used to describe specific various embodiments, and are not intended to limit the present disclosure. An electronic device according to the present disclosure may be a device including a communication function. For example, the device corresponds to a combination of at least one of a smartphone, a tablet personal computer (PC), a mobile phone, a video phone , an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a television (TV), a digital versatile disc (DVD) player, an audio device, various medical devices (for example, magnetic resonance angiography (MRA), magnetic resonance imaging (MRI), computed tomography (CT), a scanning machine, a ultrasonic wave device, or the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

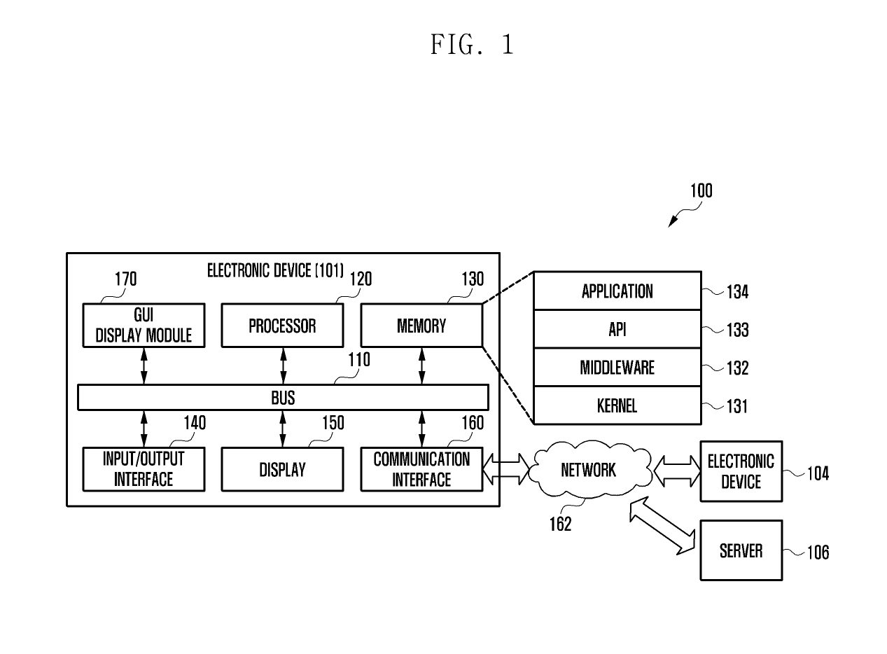

FIG. 1 illustrates a network environment including an electronic device according to various embodiments of the present disclosure.

Referring to FIG. 1, the electronic device 101 may include a bus 110, a processor 120, a memory 130, an input/output interface 140, a display 150, a communication interface 160, and a GUI display module 170.

The bus 110 may be a circuit which interconnects the above-described elements and delivers a communication (e.g., a control message) between the above-described elements.

The processor 120 may receive commands from the above-described other elements (e.g., the memory 130, input/output interface 140, the display module 150, the communication module 160, GUI display module 170, etc.) through the bus 110, may interpret the received commands, and may execute a calculation or process data according to the interpreted commands.

The memory 130 may store commands or data received from or created by the processor 120 or other elements (e.g., the input/output interface 140, the display 150, the communication interface 160, or GUI display module 170, etc.). The memory 130 may store programming modules such as a kernel 131, a middleware 132, an application programming interface (API) 133, and an application 134. Each of the programming modules may be composed of software, firmware, hardware, and any combination thereof.

The kernel 131 may control or manage system resources (e.g., the bus 110, the processor 120, or the memory 130, etc.) used for performing operations or functions of the other programming modules, e.g., the middleware 132, the API 133, or the application 134. Additionally, the kernel 131 may offer an interface that allows the middleware 132, the API 133 or the application 134 to access, control or manage individual elements of the electronic device 101.

The middleware 132 may enable the API 133 or the application 134 to communicate with the kernel 131 to transmit or receive data. Additionally, in connection with task requests received from the applications 134, the middleware 132 may control (e.g., scheduling or load balancing) the task request by using technique such as assigning the priority for using a system resource of the electronic device 101 (e.g., the bus 110, the processor 120, or the memory 130, etc.) to the application 134.

The API 133 is an interface for allowing the application 134 to control a function provided by the kernel 131 or the middleware 132 and may include, for example, at least one interface or function (e.g., a command) for a file control, a window control, an image processing, a text control, and the like.

According to various embodiments of the present disclosure, the application 134 may include a short message service (SMS)/multimedia messaging service (MMS) application, an email application, a calendar application, an alarm application, a health care application (e.g., an application for measuring quantity of motion or blood sugar), an environment information application (e.g., an application for offering information about atmospheric pressure, humidity, or temperature, etc.), and the like. Additionally or alternatively, the application 134 may be associated with an exchange of information between the electronic device 101 and any external electronic device (e.g., an external electronic device 104). This type application may include a notification relay application for delivering specific information to an external electronic device, or a device management application for managing an external electronic device.

For example, the notification relay application may deliver notification information that is created by any application of the electronic device 101 (e.g., the SMS/MMS application, the email application, the health care application, or the environment information application, etc.) to an external electronic device (e.g., the electronic device 104). Additionally or alternatively, the notification relay application may receive notification information from an external electronic device (e.g., the electronic device 104) and offer it to a user. The device management application may manage (e.g., install, remove or update) a certain function (a turn-on/turn-off of an external electronic device (or some components thereof), or an adjustment of brightness (or resolution) of a display) of any external electronic device (e.g., the electronic device 104) that is communicating with the electronic device 101, a certain application operating at such an external electronic device, or a certain service (e.g., a call service or a message service) offered by such an external electronic device.

According to various embodiments of the present disclosure, the application 134 may include a specific application based on attributes (e.g., a type) of an external electronic device (e.g., the electronic device 104). For example, in case an external electronic device is an MP3 player, the application 134 may include a specific application associated with a playback of music. Similarly, in case an external electronic device is a portable medical device, the application 134 may include a specific application associated with a health care. In an embodiment of the present disclosure, the application 134 may include at least one of an application assigned to the electronic device 101 or an application received from an external electronic device (e.g., the server 106 or the electronic device 104).

The input/output interface 140 may deliver commands or data, which are entered by a user through an input/output unit (e.g., a sensor, a keyboard, or a touch screen), to the processor 120, the memory 130, the communication interface 160, or the application control module 170 via the bus 110. For example, the input/output interface 140 may offer data about a user's touch, which is entered through the touch screen, to the processor 120. Also, through the input/output unit (e.g., a speaker or a display), the input/output interface 140 may output commands or data, received from the processor 120, the memory 130, the communication interface 160, or the application control module 170 via the bus 110. For example, the input/output interface 140 may output audio data, which is processed through the processor 120, to a user through the speaker.

The display 150 may display thereon various kinds of information (e.g., multimedia data, text data, etc.) to a user.

The communication interface 160 may perform a communication between the electronic device 101 and any external electronic device (e.g., the electronic device 104 of the server 106). For example, the communication interface 160 may communicate with any external device by being connected with a network 162 through a wired or wireless communication. A wireless communication may include, but not limited to, at least one of Wi-Fi, Bluetooth (BT), near field communication (NFC), GPS, or a cellular communication (e.g., long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), etc.). A wired communication may include, but not limited to, at least one of universal serial bus (USB), high definition multimedia interface (HDMI), recommended standard 232 (RS-232), or plain old telephone service (POTS).

According to an embodiment of the present disclosure, the network 162 may be a communication network, which may include at least one of a computer network, an Internet, an Internet of things, or a telephone network. According to an embodiment of the present disclosure, a protocol (e.g., transport layer protocol, data link layer protocol, or physical layer protocol) for a communication between the electronic device 101 and any external device may be supported by at least one of the application 134, the API 133, the middleware 132, the kernel 131, or the communication interface 160.

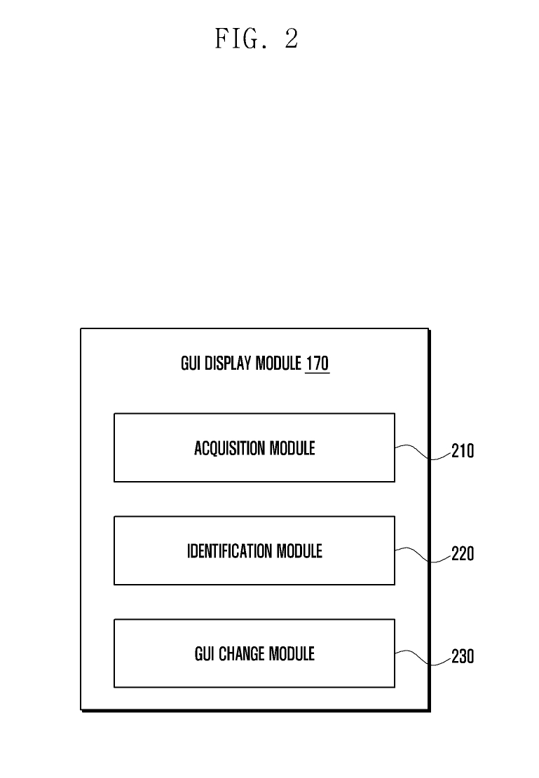

Hereinafter, additional information on the GUI display module 170 will be provided with reference to FIGS. 2 to 23.

FIG. 2 is a block diagram of the GUI display module according to various embodiments of the present disclosure.

Referring to FIG. 2, at least a part of the GUI display module 170 may be included in a programming module or the processor 120, and may be configured by software, firmware, hardware, or a combination of two or more thereof The GUI display module 170 may include an acquisition module 210, an identification module 220, and a GUI change module 230.

The acquisition module 210 may receive an input from the user. For example, when the user drags (or flicks) or scrolls the screen to switch a page or scroll an object, the acquisition module may detect the drag or scrolling and transfer the detection to the identification module 220. However, the present disclosure is not limited thereto, and the acquisition module 210 may detect an input of a hard (or physical) key (or button) of the electronic device 101 or a soft key (or a virtual key) displayed on the display 150, and transfer the detection to the identification module 220. In another example, the acquisition module 210 may receive a request for switching a page from the external electronic device 104 or the server 106, and transfer the request to the identification module 220.

The identification module 220 may identify a user input received from the acquisition module 210. For example, when the identification module 220 receives the user input from the acquisition module 210, the identification module 220 may identify whether the received input corresponds to an input for switching a page or scrolling an object displayed on the screen.

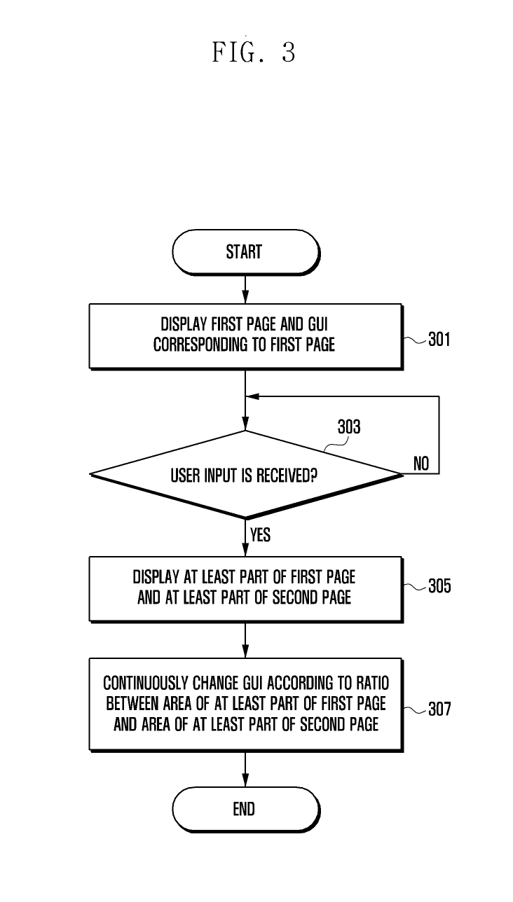

The GUI change module 230 may change a GUI based on the user input identified by the identification module 220. According to an embodiment of the present disclosure, when the page is switched, the GUI change module 230 may control the display 150 to display a changed page indicator corresponding to at least one of the displayed page and the switched page. According to an embodiment of the present disclosure, when the object displayed on the screen is scrolled, the GUI change module 230 may control the display 150 to display a continuously changed object indicator corresponding to the scrolled object. Hereinafter, a GUI display method implemented through the GUI display module 170 will be described in detail with reference to FIGS. 3 to 25.

According to various embodiments of the present disclosure, an electronic device may include a display, a user input device, and a processor, and the processor may display a first page among a plurality of pages and a GUI corresponding to the first page on a screen, display at least a part of the first page and at least a part of a second page adjacent to the first page among the plurality of pages based on a user input received in at least one of an area in which the first page is displayed and an area in which the GUI is displayed, and continuously change the displayed GUI according to a ratio between an area of at least the part of the displayed first page and an area of at least the part of the displayed second page.

According to various embodiments of the present disclosure, the GUI may include page indicators.

According to various embodiments of the present disclosure, the processor may control the display to continuously change at least one of a size, slope, color, color depth, thickness, and area of the page indicator.

According to various embodiments of the present disclosure, the processor may insert a third page or remove the first page, and control the display to continuously change the page indicator when the third page is inserted or the first page is removed.

According to various embodiments of the present disclosure, the processor may control the display to continuously change the page indicator based on at least one of a speed, intensity, and pressure of the received user input.

According to various embodiments of the present disclosure, the processor may increase or decrease an area of the first page in a state where the first page is displayed in the middle of the screen, and control the display to continuously change the page indicator when the area of the first page is increased or decreased.

According to various embodiments of the present disclosure, the processor may control the display to continuously change the page indicator in a different way according to a page switching type.

According to various embodiments of the present disclosure , when the user input is received, the processor may move the page indicator displayed in the area to another area and display the page indicator in the moved area.

According to various embodiments of the present disclosure , the processor may control the display to display the page indicator based on a characteristic of an object included in each of the plurality of pages.

According to various embodiments of the present disclosure , an electronic device may include a display, a user input device, and a processor, and the processor may display a plurality of objects and a GUI corresponding to the objects on a screen, scroll the objects based on a user input received in at least one of an area in which the objects are displayed and an area in which the GUI is displayed, and continuously change the GUI according to a scrolling distance of the objects.

According to various embodiments of the present disclosure, the processor may control he display to continuously change the GUI including an object indicator.

According to various embodiments of the present disclosure, processor may control the display to continuously change at least one of a size, slope, color, color depth, thickness, and the object indicator.

According to various embodiments of the present disclosure, the processor may control the display to continuously change the object indicator according to a group or a page including the objects.

According to various embodiments of the present disclosure, when the objects correspond to contents, the processor may reproduce the contents and control the display to continuously change the GUI in accordance with time information on reproduction of the contents.

FIG. 3 illustrates a flowchart for a method of displaying a GUI according to an embodiment of the present disclosure.

Referring to FIG. 3, the processor 120 may control the display 150 to display a currently displayed page (hereinafter, referred to as a “first page”) from a plurality of pages and a GUI corresponding to the first page in operation 301.

According to an embodiment of the present disclosure, the screen may include a home screen or a menu screen. However, the home screen or menu screen is only an example, and the screen may include all screens, which can display an object, for example, an icon, an item, a file, an image, or any other content. The screen may include a plurality of pages, and each of the pages may include an object. However, according to an embodiment of the present disclosure, the page may not include the object. For example, one of the pages of the menu screen may be an empty page, which does not include an object (for example, an icon).

According to an embodiment of the present disclosure, the screen may include a first area for displaying at least a part of the plurality of pages including the first page and a second area as an area for displaying a GUI corresponding to the first page. According to an embodiment of the present disclosure, the first area and the second area do not overlap each other, and may be arranged close to each other or separated by a predetermined interval. According to an embodiment of the present disclosure, the first area and the second area may be displayed on respective layers. When the first area and the second area are displayed on their respective layers, the first area may be overlaid with the second area. According to an embodiment of the present disclosure, if the first area and the second area do not overlap each other, the processor 120 may control the display 150 to display the GUI displayed in the second area to overlap at least a part of a predetermined area of the first area based on a particular user input.

According to an embodiment of the present disclosure, the GUI displayed in the second area may be a page indicator including an indication corresponding to the first page and indications corresponding to the remaining pages.

The page indicator may be displayed in various forms. According to an embodiment of the present disclosure, the processor 120 may control the display 150 to display the page indicator in the form of a dot, a bar, a polygon having an area, an English letter, or a number.

According to an embodiment of the present disclosure, the processor 120 may control the display 150 to display the page indicator to distinguish the first page, which is currently displayed on the screen, from other pages, which are not displayed on the screen. For example, when the page indicator is a bar type, the processor 120 may control the display 150 to display indicators in such a manner that at least one of a length, size, thickness, color, and shade (or depth) of a color of the indicator corresponding to the first page is distinguished from those of indicators corresponding to other pages.

According to an embodiment of the present disclosure, the processor 120 may control the display 150 to display page indicators in various forms based on the number of objects included in each of the plurality of pages. For example, when the page indicator is a bar type, the processor 120 may control the display 150 to display the indicators in such a manner that at least one of a length, size, thickness, color, or shade of a color of the indicator is different according to the number of objects (for example, icons) that are included in each of the plurality of pages. According to an embodiment of the present disclosure, the processor 120 may control the display 150 to display page indicators in various forms based on characteristics of objects included in each of the plurality of pages. For example, when the plurality of pages include objects belonging to different categories, respectively, the processor 120 may control the display 150 to display the page indicator corresponding to the category.

According to an embodiment of the present disclosure, when the electronic device corresponds to a dual display electronic device having two displays 150, the processor 120 may control the two displays 150 to display at least some of the plurality of pages including the first page through one of the two displays 150 and display the page indicator through the other display.

According to an embodiment of the present disclosure, the processor 120 may make a control to display at least some of the plurality of pages including the first page on the display 150 and display the page indicator on the display 150 of the external electronic device through interworking with the external electronic device.

In operation 303, the processor 120 may identify whether a user input is received for at least one of the first area and the second area. For example, when the user touches, for example, drags or flicks at least one of the first area and the second area in order to switch the first page, which is displayed on the screen, to another page, an event corresponding to the drag or flick may be received. According to an embodiment of the present disclosure, when the user drags the first area or the second area in order to add a page to the screen or remove the currently displayed first page, an event corresponding to the drag may be received. Although the user input by the touch for the page switching, page insertion, or page addition is described, the present disclosure is not limited thereto. For example, the processor 120 may receive a hard (or physical) key (or button) of the electronic device or a soft key (or virtual key) displayed on the display 150 and execute a function of switching, inserting, or adding the page. In another example, the processor 120 may receive a signal from an external electronic device and perform an operation for switching, inserting, or adding the page. When the user input is not received in operation 303, the processor 120 may display the first page and the GUI corresponding to the first page until the user input is received.

According to an embodiment of the present disclosure, when the processor 120 receives the user input in operation 303, the processor 120 may control the display 150 to display at least a part of the currently displayed first page and at least a part of the second page that is adjacent to the first page based on the received user input in operation 305.

According to an embodiment of the present disclosure, at least a part of the second page may be arranged at a predetermined interval from the first page. When the user input is received, for example, when the user drags the first area to switch the page, the processor 120 may control the display 150 to display a boundary of the edge of the first page and a boundary of the edge of the second page at a predetermined interval from the boundary of the edge of the first page.

According to an embodiment of the present disclosure, in operation 307, the processor 120 may control the display 150 to display a continuously changed GUI according to a ratio between an area of the at least part of the first page and an area of the at least part of the second page. For example, the page indicator may be implemented in a bar type. The processor 120 may control the display 150 to display the at least part of the first page and the at least part of the second page from the screen displaying the first page according to a screen switching input by the user. The processor 120 may control the display 150 such that slopes of the page indicator corresponding to the first page and the page indicator corresponding to the second page are changed in accordance with (or in consideration of) a display radio change of an area of the at least part of the first page and an area of the at least part of the second page displayed on the screen (or a change amount of at least a partial area of the first page and at least a partial area of the second page displayed on the screen). In another example, the processor 120 may control the display 150 such that at least one of the length, size, thickness, color, and shade (depth) of a color of the page indicator corresponding to the first page and the page indicator corresponding to the second page is continuously changed. However, the changed form of the page indicator according to the page switch is not limited to the above described example, and it is apparent to those skilled in the art that all forms, which can express the continuously changed page indicator, can be applied.

According to an embodiment of the present disclosure, the processor 120 may control the display 150 such that the form in which the page indicator is continuously changed according to a user input is differently displayed. The processor 120 may control the display 150 such that the form in which the page indicator is continuously changed is displayed differently based on a speed, intensity, or pressure of the user input. For example, when the page indicator is a bar type, if the user inputs a drag by touching the screen with a user's finger at a fast speed, the processor 120 may make a control to lower a change in the slope of the page indicator compared to a case where the drag is input at a slow speed.

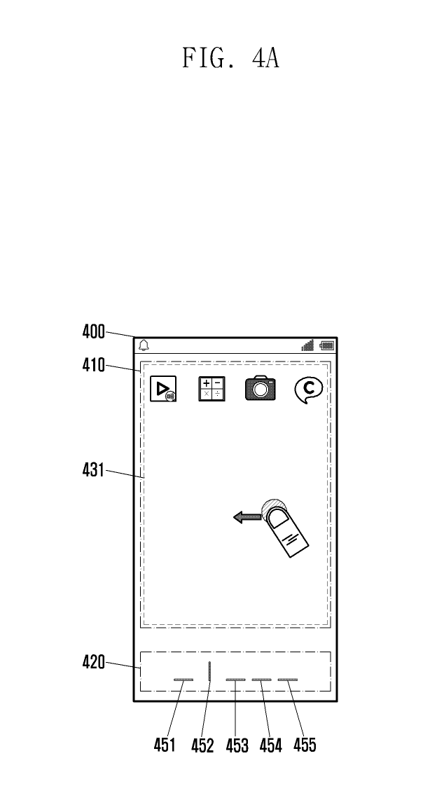

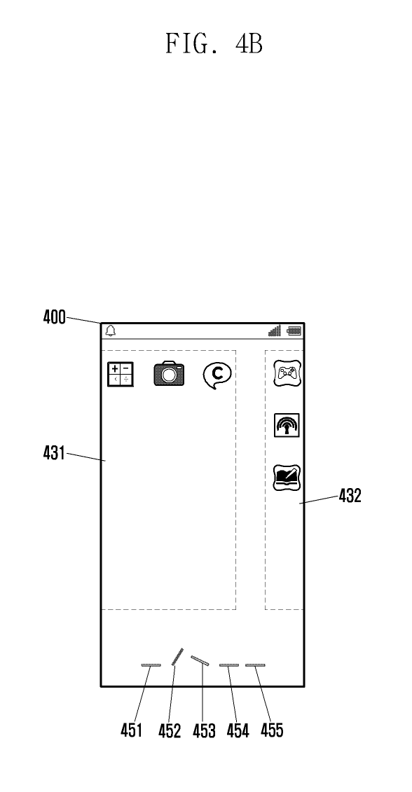

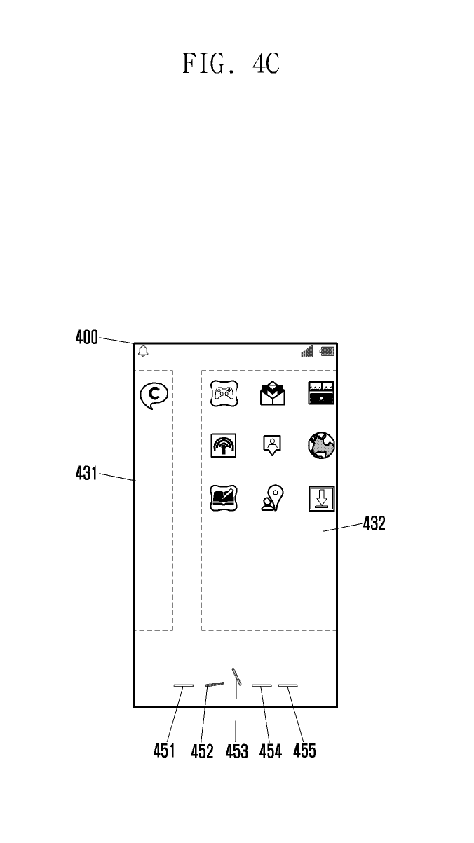

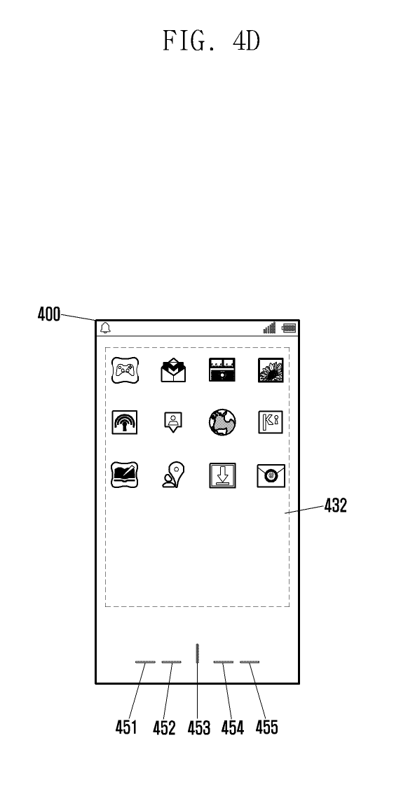

FIGS. 4A, 4B, 4C, and 4D illustrate an example for describing a method of displaying a GUI according to an embodiment of the present disclosure.

Referring to FIG. 4A, in FIG. 4A, the processor 120 may control the display 150 to display a page 431 in a first area 410 of a screen 400 (for example, a menu screen) and display page indicators 451-455 in a bar type in a second area 420. The processor 120 may control the display 150 to display the page indicators 451-455 in accordance with the page 431. For example, when the page indicators 451-455 are the bar type, the processor 120 may control the display 150 to vertically display the page indicator 452 corresponding to the page 431 and horizontally display the remaining page indicators 451, 453, 454, and 455, so as to indicate a second page among a total of five pages.

When the user makes an input for controlling a screen in the first area 410, for example, when the user drags a screen 400 in a left direction, FIGS. 4B, 4C, and 4D illustrate the continuously displayed screen 400. As the page 431 is switched in the left direction based on the user input, the processor 120 may control the display 150 to display a part of the page 431 and a part of the page 432 in the FIGS. 4B and 4C.

According to an embodiment of the present disclosure, the processor 120 may control the display 150 to continuously change the page indicators 451-455 displayed in the second area according to a ratio between a display area of the part of the page 431 and a display area of the part of the page 432. For example, the processor 120 may control the display 150 to display the page indicator 452 corresponding to the page 431 of the screen 400 in FIG. 4C at a slope smaller than that of the page indicator 452 corresponding to the page 431 displayed in FIG. 4B. The processor 120 may control the display 150 to display the page indicator 453 corresponding to the page 432 in FIG. 4C at a slope larger than that of the page indicator 453 corresponding to the page 432 displayed in FIG. 4B. In FIG. 4D, the processor 120 may control the display 150 to display the switched page 432 in the first area 410 of the screen 400. The processor 120 may control the display 150 to vertically display the page indicator 453 corresponding to the switched page 432.

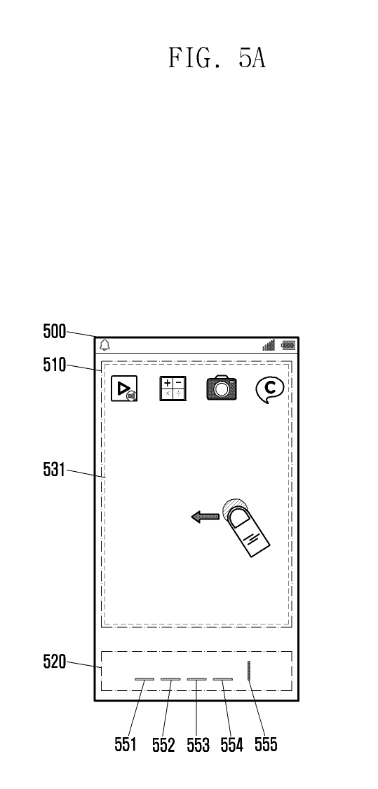

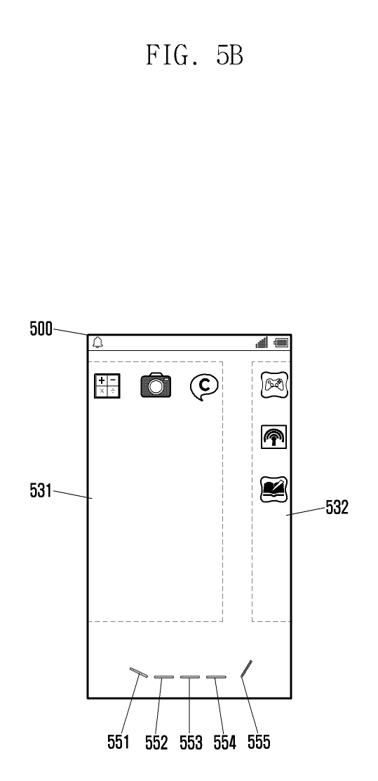

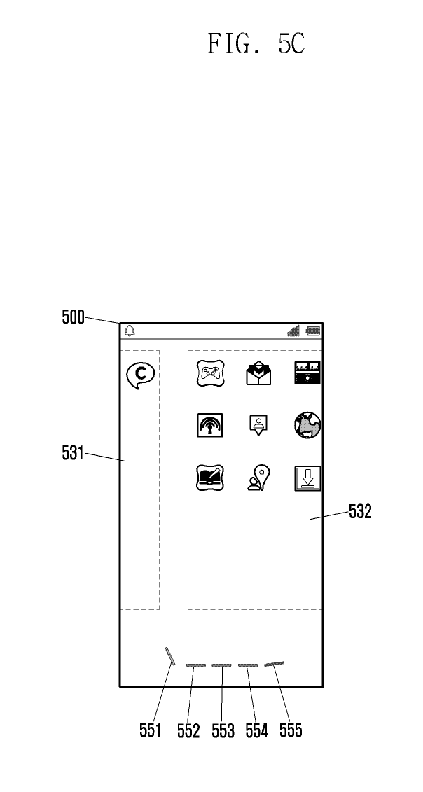

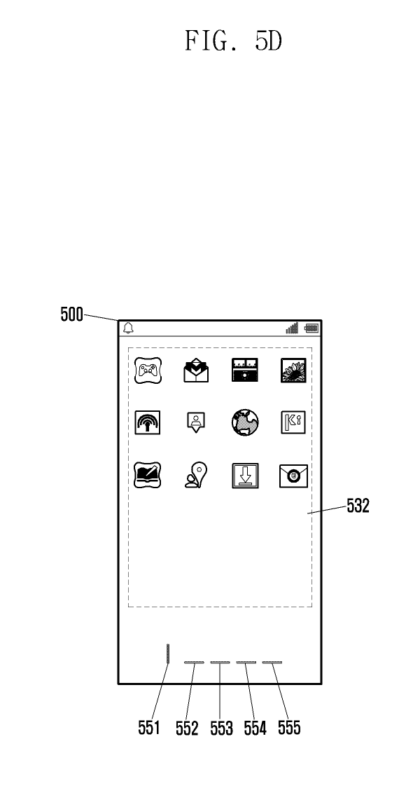

FIGS. 5A, 5B, 5C, and 5D illustrate an example for describing a method of displaying a GUI according to various embodiments of the present disclosure.

Referring to FIGS. 5, 5B, 5C, and 5D, illustrated is an example method of displaying a GUI when page switching is made in a circular scheme, for example, when a page switch can be made from a last page to a first page among a plurality of pages. The processor 120 may control the display 150 to display a last page among a plurality of pages included in a menu screen as a page 531 in a first area 510 of a screen 500 (for example, the menu screen) and display page indicators 551-555 in a bar type in a second area 520 in FIG. 5A.

When the user makes a user input on the page 531 displayed in the first area if FIG. 5A, that is, when the user drags a screen 500 in a left direction, FIGS. 5B, 5C, and 5D illustrate the continuously displayed screen 500. As the page 531 is switched in the left direction based on the user input, the processor 120 may control the display 150 to display a part of the page 531 and a part of the page 532 as the first page among the plurality of pages included in the menu in FIGS. 5B, 5C, and 5D.

According to an embodiment of the present disclosure, the processor 120 may control the display 150 to continuously change the page indicators 551-555 displayed in the second area according to a ratio between a display area of the part of the page 531 and a display area of the part of the page 532. For example, the processor 120 may control the display 150 to display the page indicator 555 corresponding to the page 531 in FIG. 5C at a slope smaller than that of the page indicator 555 corresponding to the page 531 displayed in FIG. 5B. The processor 120 may control the display 150 to display the page indicator 551 corresponding to the page 532 at a slope larger than that of the page indicator 551 corresponding to the page 532 displayed in FIG. 5B. In FIG. 5D, the processor 120 may control the display 150 to display the switched page 532 in the first area 531 of the screen 500. The processor 120 may control the display 150 to vertically display the page indicator 551 corresponding to the switched page 532.

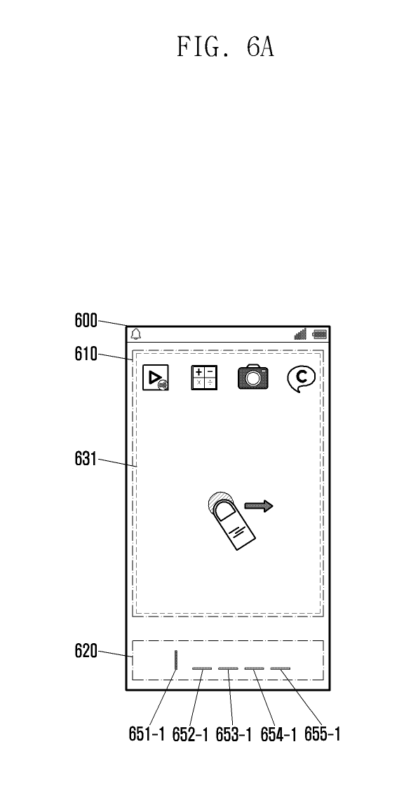

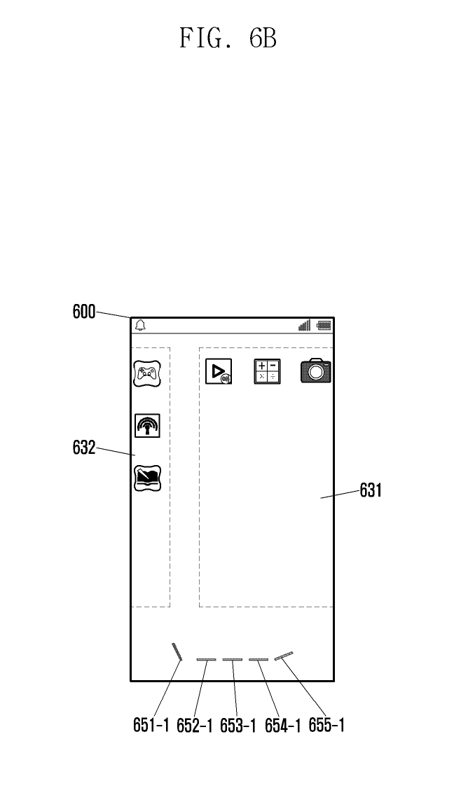

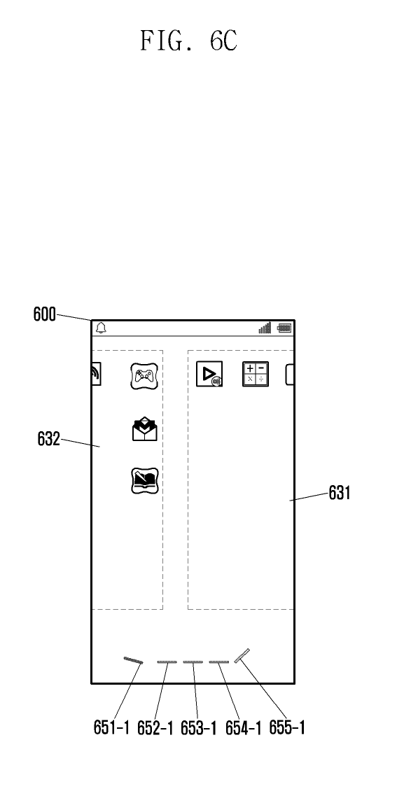

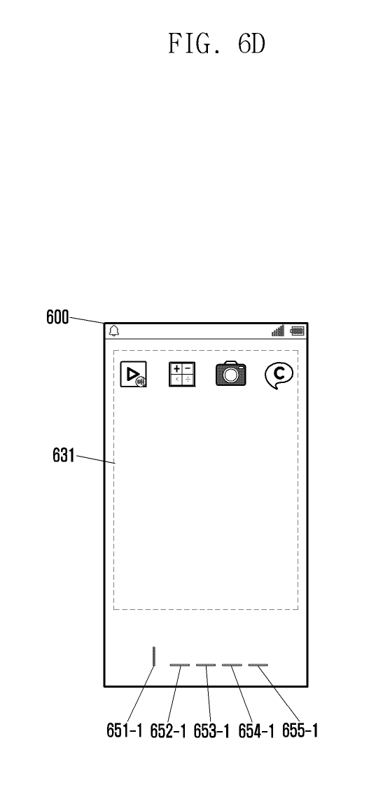

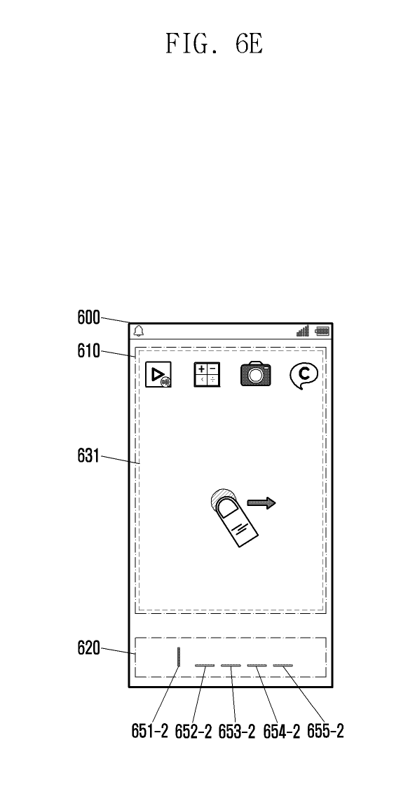

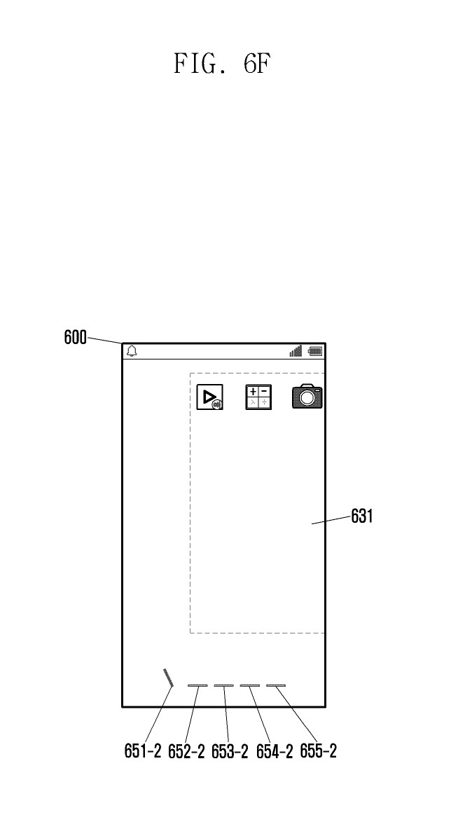

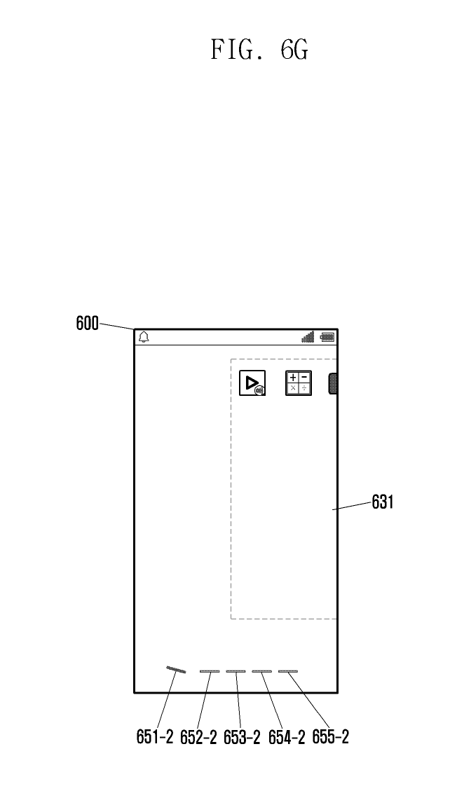

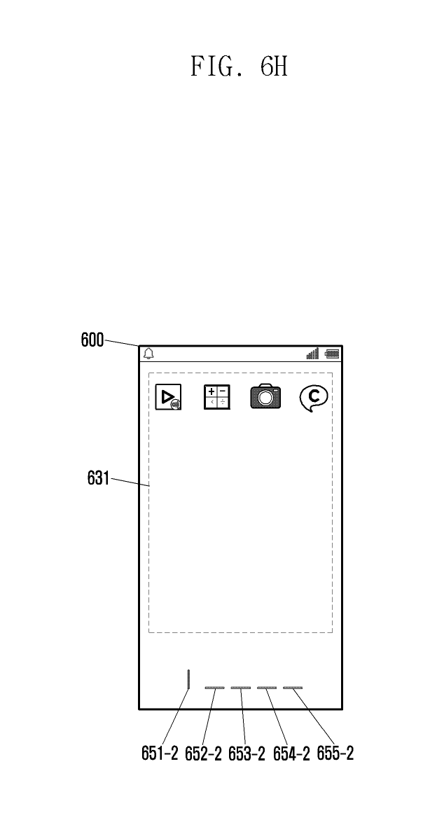

FIGS. 6A, 6B, 6C, 6D, 6E, 6F, 6G, and 6H illustrate examples for describing a method of displaying a GUI according to various embodiments of the present disclosure. FIGS. 6A and 6B illustrate examples for describing a method of displaying a GUI when page switching is made in a non-circular scheme, for example, when page switching is made from a last page to a first page among a plurality of pages.

Referring to FIGS. 6A, 6B, 6C, and 6D, the processor 120 may control the display 150 to display a page 631 in a first area 610 of a screen 600 (for example, a menu screen) as a first page of a plurality of pages and display page indicators 651-1-655-1 in a bar type in a second area 620. The processor 120 may control the display 150 to display the page indicator 651 in accordance with the page 631. For example, when the page indicators 651-1-655-1 are the bar type, the processor 120 may control the display 150 to vertically display the page indicator 651-1 and horizontally display the remaining page indicators 652-1-655-1, so as to indicate a first page among a total of five pages.

When the user makes a user input in the first area 610 of FIG. 6A, that is, when the user drags the screen 600 in a right direction, FIGS. 6B, 6C, and 6D correspond to the continuously displayed screens. As the page 631 is switched in the right direction based on the user input, the processor 120 may control the display 150 to display a part of the page 631 and a part of the page 632 corresponding to a last page in FIGS. 6B and 6C.

In FIGS. 6B, 6C, and 6D, the processor 120 may control the display 150 to display the indicator 651-1 and 655-1, of which the form are continuously changed according a ratio between at least the part of the page 631 displayed through the first area and at least the part of the page 632 displayed through the second area. According to an embodiment of the present disclosure, the processor 120 may control the display 150 to display the indicator 655-1 corresponding to the page 632, of which the form is not changed while the form the indicator 651-1 corresponding to the page 631 is changed.

In FIG. 6D, the processor 120 may control the display 150 to display the page 631 and vertically display the page indicator 651-1 in the bar type corresponding to the page 631.

Referring to FIGS. 6E, 6F, 6G, and 6H, the processor 120 may control the display 150 to display the page 631 in the first area 610 of the screen 600 (for example, a menu screen) as a first page of a plurality of pages and display page indicators 651-2-655-2 in a bar type in the second area 620. The processor 120 may control the display 150 to display the page indicator 651-2 in accordance with the page 631. For example, when the page indicators 651-2-655-2 are the bar type, the processor 120 may control the display 150 to vertically display the page indicator 651-2 and horizontally display the remaining page indicators 652-2-655-2, so as to indicate the first page among a total of five pages.

When the user makes a user input in the first area 610 of the screen 600, that is, when the user drags the screen 600 in a right direction, FIGS. 6F, 6G, and 6H correspond to the continuously displayed screens. As the page 631 is switched in the right direction based on the user input, the processor 120 may control the display 150 to display only a part of the page 631 and display nothing on a page on the left of the page 631 in FIGS. 6F and 6G. As only the page 631 is displayed, the processor 120 may control the display 150 to continuously change the page indicator 651-2 corresponding to the page 631. According to an embodiment of the present disclosure, the processor 120 may control the display 150 to not change the remaining page indicators 652-2-655-2.

As the moved page 631 returns to the original position, the processor 120 may control the display 150 to vertically display the page indicator 651-2 corresponding to the page 631 in FIG. 6H.

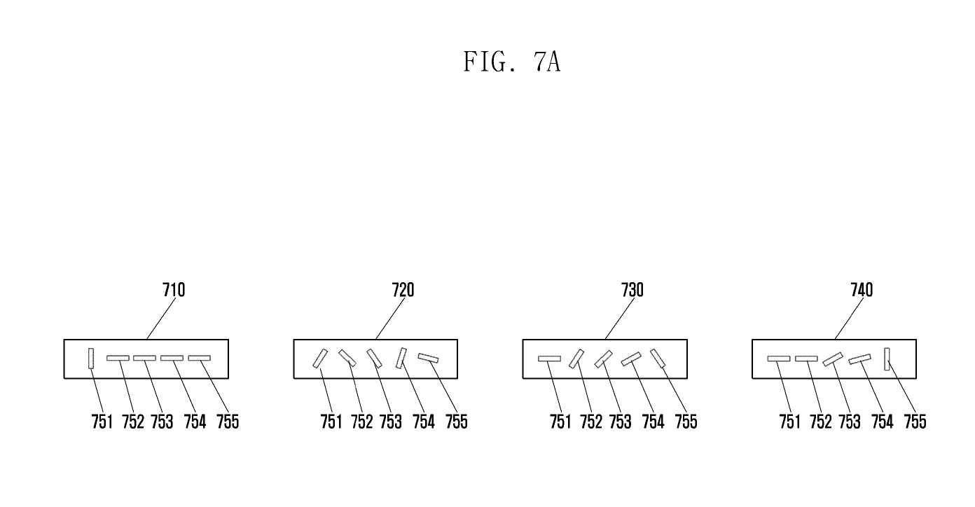

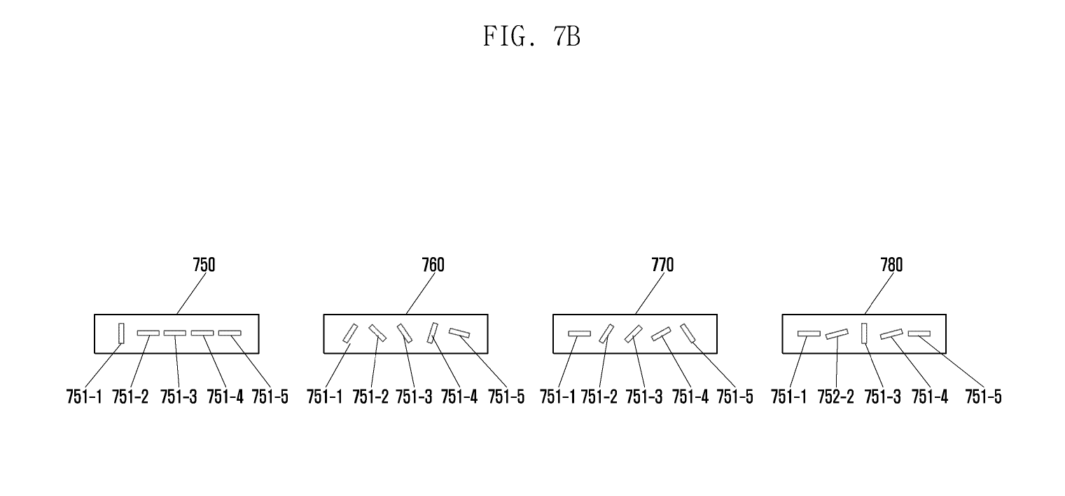

FIGS. 7A and 7B illustrate an example for describing a method of displaying a GUI according to an embodiment of the present disclosure.

Referring to FIGS. 7A and 7B, an example for describing the form of the continuously changed page indicator based on a user input, for example, a speed, intensity, or pressure of the user input is illustrated. In FIG. 7A, reference numerals 710-740 illustrate page indicators 751-755 that are displayed in the second area. When the user touches (for example, drags or flicks) the first area or the second area of the screen at a fast speed, the processor 120 may control the display 150 to display the page indicators 751-755 in different forms according to a touch input speed. For example, compared to FIG. 4, when the processor 120 receives a user input at a faster speed than the user input received in FIG. 4, the processor 120 may control the display 150 to display the indicators as indicated by reference numeral 720-740 such that forms of three or more of the page indicators 751-755 are simultaneously changed and displayed. The processor 120 may make a control such that the forms of the page indicators 751-755 are continuously changed after the corresponding page is switched.

Referring to FIG. 7B, reference numerals 750-780 illustrate page indicators 751-1-751-5 that are displayed in the second area. When the user stops (or holds) touching the first area or the second area of the screen while touching (for example, dragging or flicking) the first area or the second area at a fast speed, the processor 120 may control the display 150 to continuously display the page indicators 751-1-751-5 based on the stop or holding. For example, when a user input (for example, a drag) having a fast speed is received while the first page is switched to the third page and then no user input is received as indicated by reference numerals 750-780, the processor 120 may control the display 150 to display continuously changed page indicators 751-4 and 751-5 corresponding to the fourth page and the fifth page, respectively, as pages, which are not displayed in the first area.

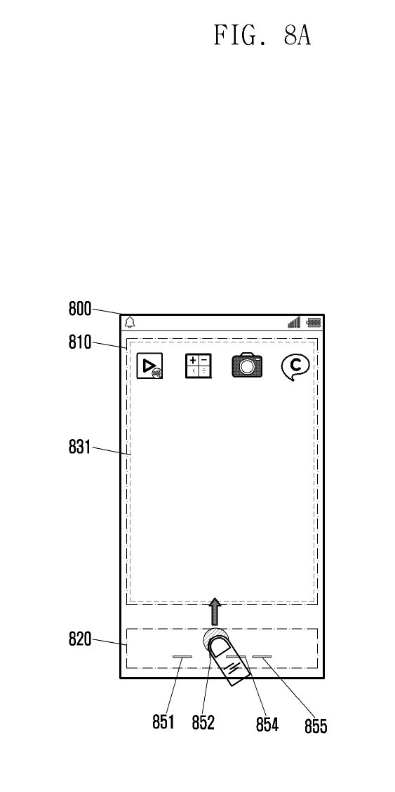

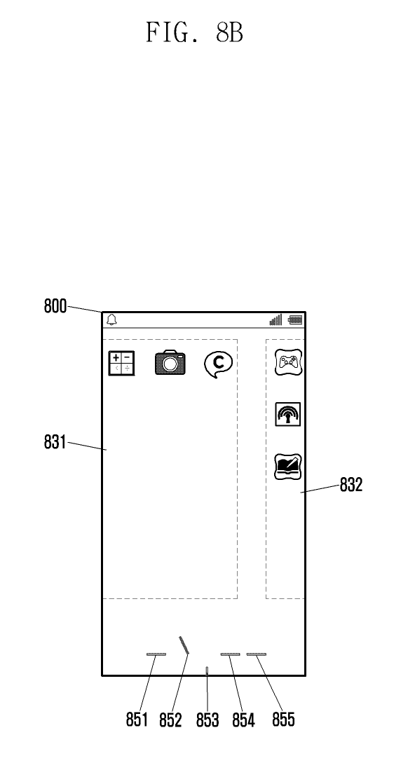

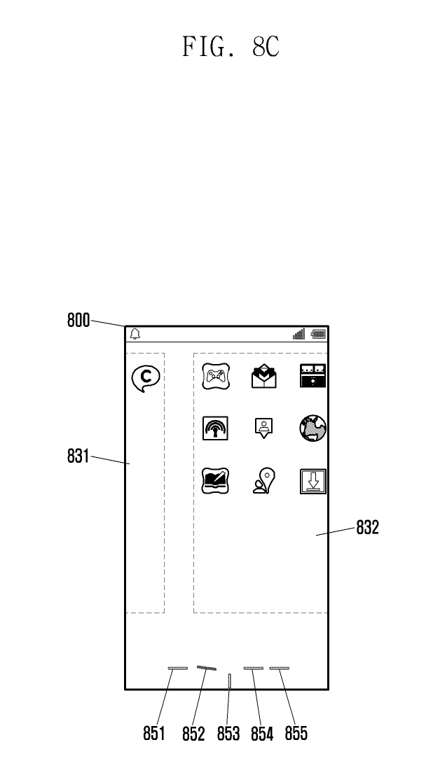

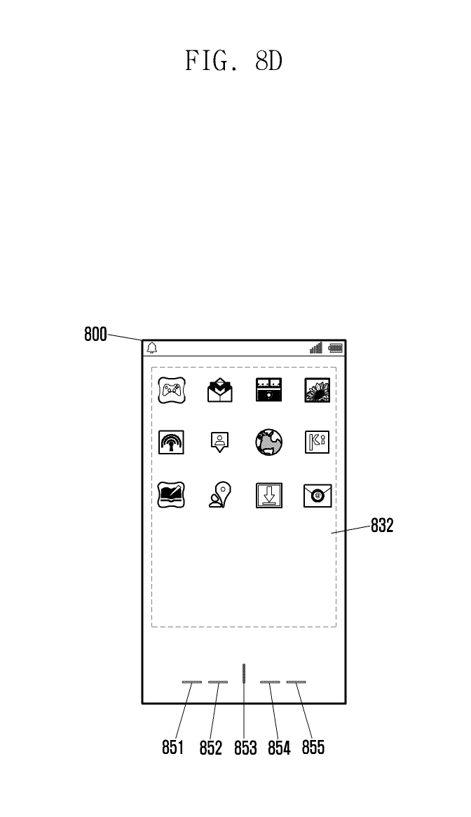

FIGS. 8A, 8B, 8C, and 8D illustrate an example for describing a method of displaying a GUI according to an embodiment of the present disclosure. FIG. 8 illustrates a changed GUI when a page is inserted.

Referring to FIGS. 8A, 8B, 8C, and 8D, illustrated in a changed GUI when a page is inserted The processor 120 may control the display 150 to display a page 831 in a first area 810 of a screen 800 (for example, a menu screen) and display page indicators 851-855 in a bar type in a second area 820. The processor 120 may control the display 150 to display the page indicator 852 in accordance with the page 831. For example, when the page indicators 851-855 are the bar type, the processor 120 may control the display 150 to vertically display the page indicator 852 and horizontally display the remaining page indicators 851, 854, and 855, so as to indicate a second page among a total of four pages as the page 831.

When the user touches (for example, drags or flicks) the second area 820 in a vertically up direction in FIG. 8A, the processor 120 may control the display 150 to display the page 832 in the first area 810 as illustrated in FIGS. 8B, 8C, and 8D. However, the present disclosure is not limited thereto, and the processor 120 may control the display 150 to receive a touch input in a vertical direction in the first area 810 and display the page 832 based on the received touch input. In another example, the processor 120 may control the display 150 to display the page 832 in the first area based on an input of making a touch in a vertically down direction.

According to an embodiment of the present disclosure, the page 832 may be inserted through page editing (or page configuration). For example, the processor 120 may generate a new page in a page editing screen, which displays a plurality of pages in a thumbnail form, based on a user input. When a page editing end input is received from the user, the processor may control the display 150 to display the new page 832 and display a continuously changed page indicator 853 in accordance with the page 832 as illustrated in FIGS. 8A, 8B, 8C, and 8D. According to an embodiment of the present disclosure, the page 832 may be inserted through a method of moving or cutting one of the plurality of pages and then copying the page. According to an embodiment of the present disclosure, the processor 120 may continuously change the forms of the pages indicators 852 and 853 according to a ratio between a display area of at least a part of the page 831 and a display area of least a part of the page 832. For example, as the area of the page 831 becomes smaller and the area of the page 832 becomes larger, the processor 120 may control the display 150 to decrease a slope of the page indicator 852, which is vertically displayed and increase a length of the page indicator 853 corresponding to the page 832 in FIGS. 8A, 8B, 8C, and 8D. FIG. 8D corresponds to a screen, which displays the page 832 and the page indicator 853 corresponding to the page 832, which is vertically displayed.

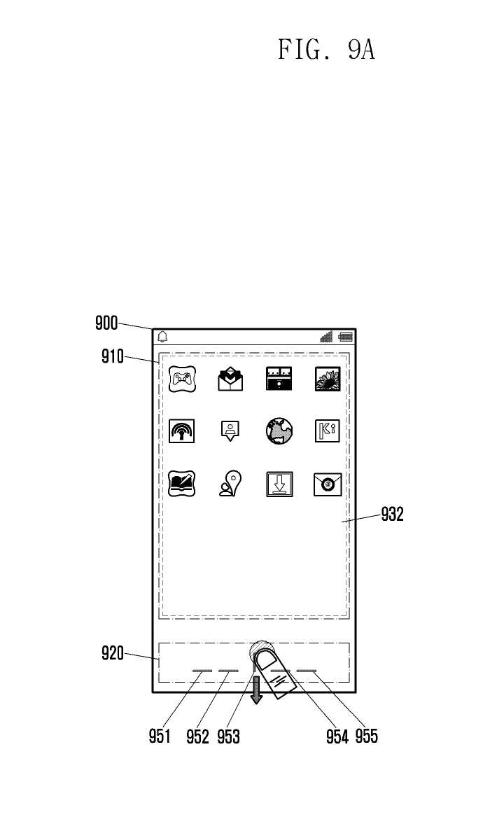

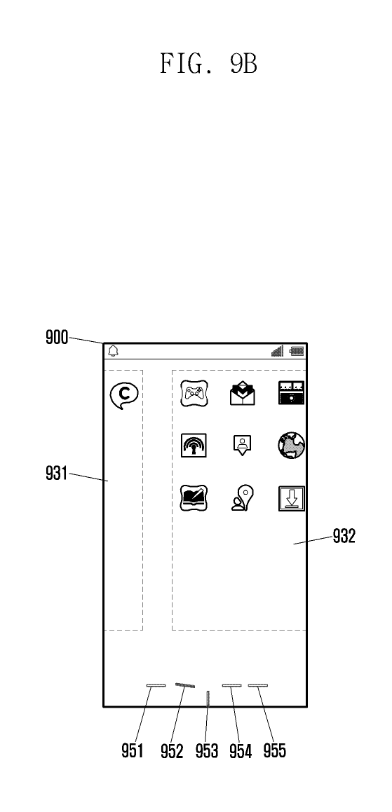

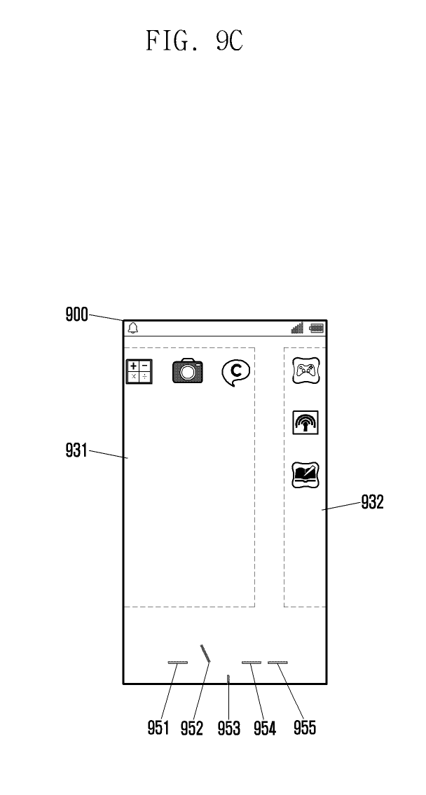

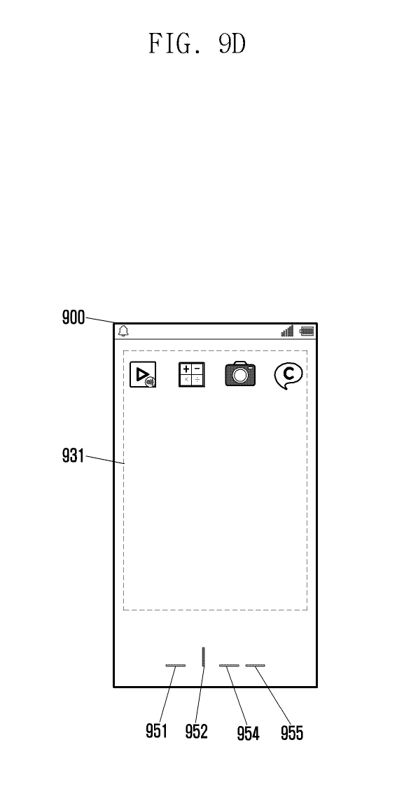

FIGS. 9A, 9B, 9C, and 9D illustrate an example for describing a method of displaying a GUI according to an embodiment of the present disclosure.

Referring to FIGS. 9A, 9B, 9C, and 9D, illustrated is a changed GUI when a page is removed. For example, FIG. 9A illustrates that, when the user touches (for example, drags or flicks) a second area 920 in a vertically down direction, the processor 120 may control the display 150 to remove page 932 displayed in a first area 910 as illustrated in FIGS. 9B, 9C, and 9D. However, the present disclosure is not limited thereto, and the processor 120 may control the display 150 to receive a touch input in a vertical direction in the first area 910 and remove the page 932 based on the received touch input. In another example, the processor 120 may remove the page 932 displayed in the first area 910 based on an input of making a touch in a vertically up direction.

According to an embodiment of the present disclosure, the processor 120 may continuously change the forms of the page indicators 952 and 953 according to a ratio between a display area of at least a part of the page 932 and a display area of at least a part of the page 931 displayed in the first area 910 as a page adjacent to the page 932. For example, as the display area of the page 931 increases and the display area of the page 932 decreases, the processor 120 may control the display 150 to decrease a length of the page indicator 953, which is vertically displayed and increase a slope of the page indicator 952 corresponding to the page 931 in FIG. 9A, 9B, 9C, and 9D. FIG. 9D corresponds to a screen, which vertically displays the page 931 and the page indicator 952 corresponding to the page 931.

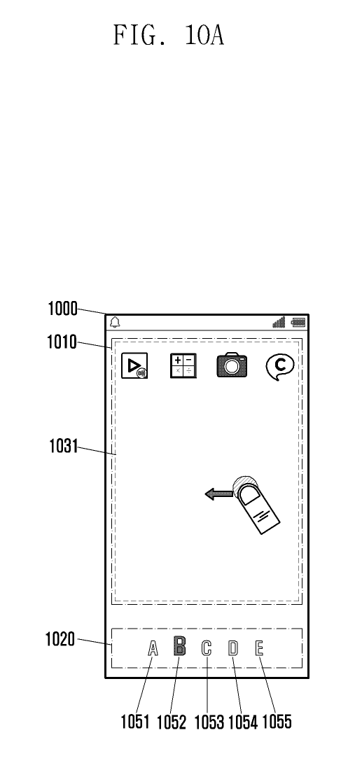

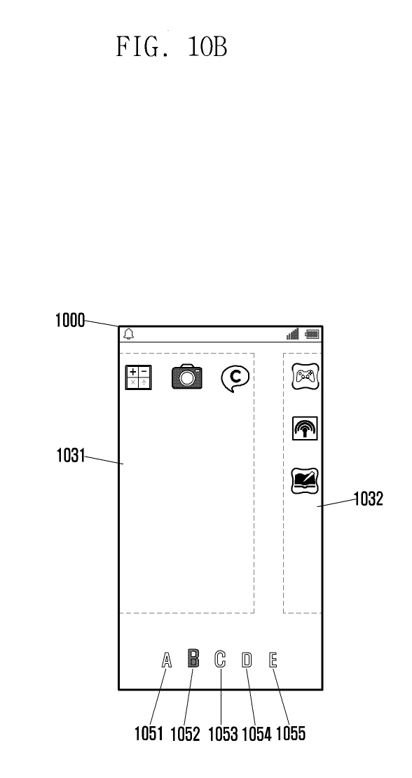

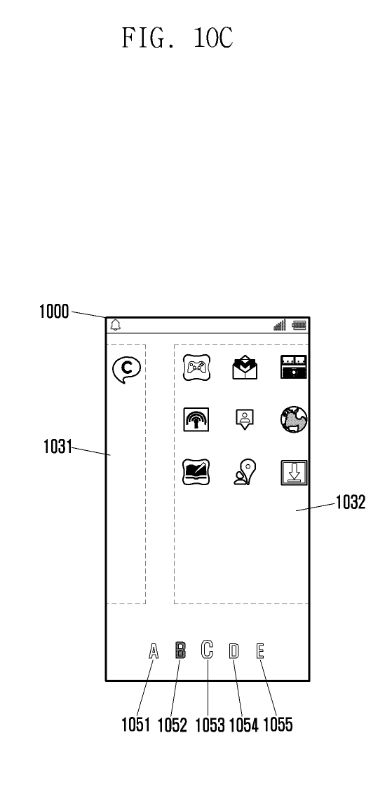

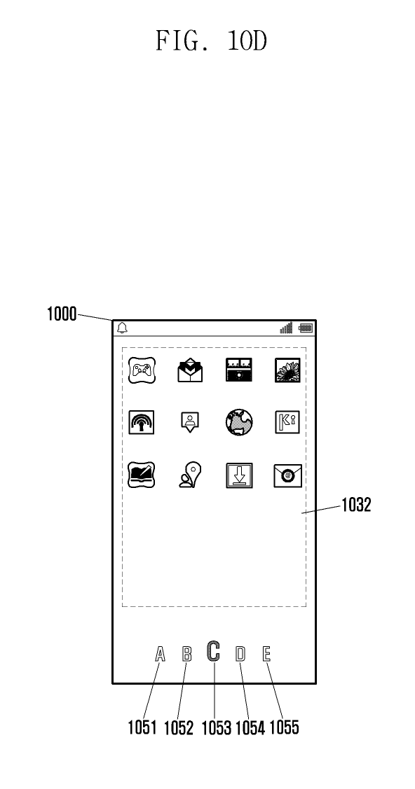

FIGS. 10A, 10B, 10C, and 10D illustrate an example for describing a method of displaying a GUI according to an embodiment of the present disclosure.

Referring to FIGS. 10A, 10B, 10C, and 10D, the processor 120 may control the display 150 to display a currently displayed page 1031 in a first area 1010 of a screen 1000 (for example, a menu screen) and display page indicators 1051-1055 as English letters in a second area 1020 in FIG. 10A. The processor 120 may control the display 150 to display the page indicator 1052 in accordance with the page 1031. For example, when the page indicators 1051-1055 are English letters, the processor 120 may control the display 150 to display the page indicator 1052 in a large size and display the remaining page indicators 1051, 1053, 1054, and 1055 in a smaller size

FIGS. 10B, 10C, and 10D correspond to the continuously displayed screens when the user makes a user input in the first area 1010 of FIG. 10A, that is, when the user drags the screen 1000 in a left direction. As the page 1031 is switched in the left direction based on the user input, the processor 120 may control the display 150 to display a part of the page 1031 and a part of the page 1032 as illustrated in FIGS. 10B and 10C.

According to an embodiment of the present disclosure, the processor 120 may control the display 150 to continuously change the page indicators 1051-1055 displayed in the second area 1020 according to a ratio between a display area of the part of the page 1031 and a display area of the part of the page 1032. For example, the processor 120 may control the display 150 to decrease the size of the page indicator 1052 indicated by the English letter “B” as the display area of the page 1031 decreases, and simultaneously to increase the size of the page indicator 1053 indicated by the English letter “C” as the display area of the page 1032 increases. In FIG. 10D, the processor 120 may make a control to display the page 1032 in the first area 1010. The processor 120 may control the display 150 to display the page indicator 1053 corresponding to the page 1032 in a large size and display the other page indicators 1051, 1052, 1054, and 1055 in a smaller size than that of the page indicator 1053 in the second area 1020.

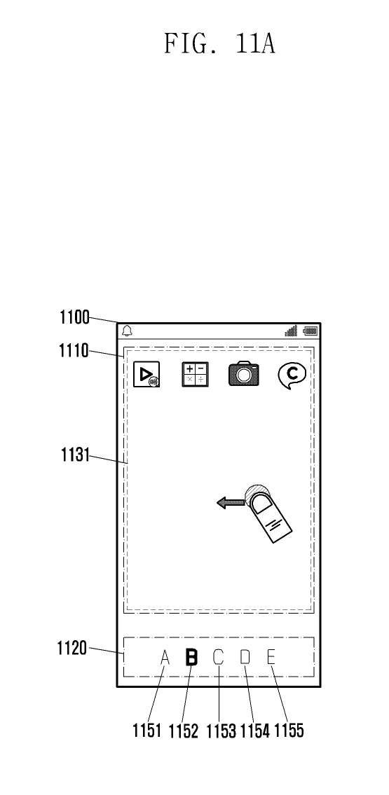

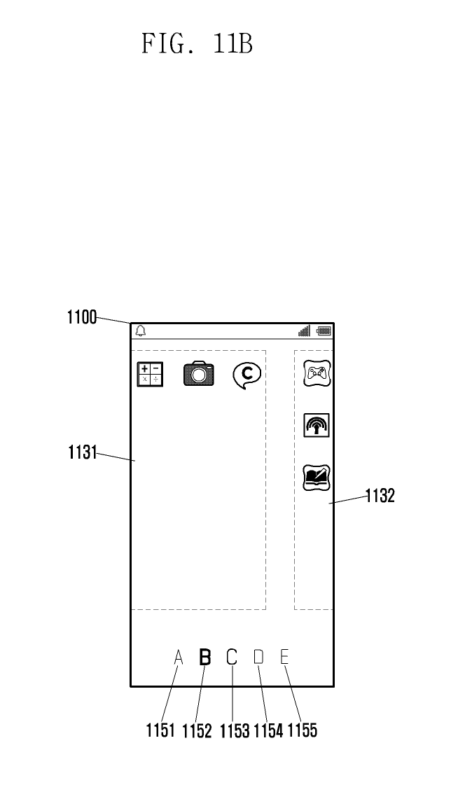

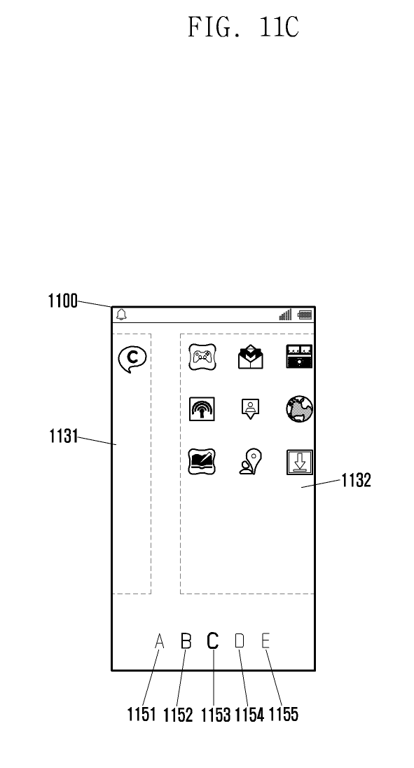

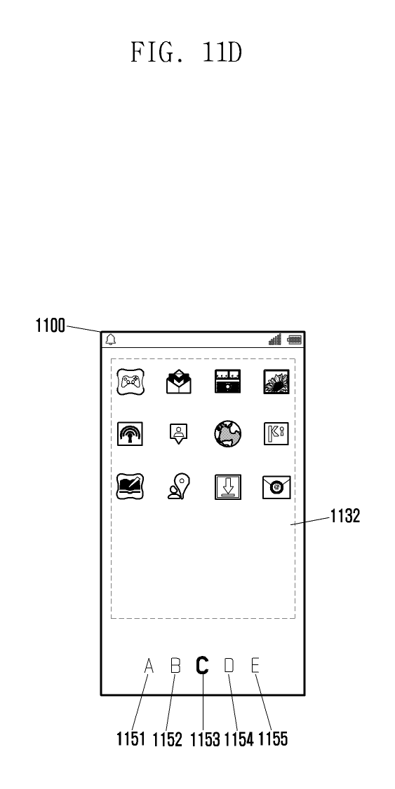

FIGS. 11A, 11B, 11C, and 11D illustrate an example for describing a method of displaying a GUI according to an embodiment of the present disclosure.

Referring to FIGS. 11A, 11B, 11C, and 11D, the processor 120 may control the display 150 to display a currently displayed page 1131 in a first area 1110 of a screen 1100 (for example, a menu screen) and display page indicators 1151-1155 in English letters in a second area 1120 in FIG. 11A. The processor 120 may control the display 150 to display the page indicator 1152 in accordance with the page 1131. For example, when the page indicators 1151-1155 are English letters, the processor 120 may control the display 150 to display the page indicator 1152 having a heavier (i.e., thicker) font (or with a large area) and display the remaining page indicators 1151, 1153, 1154, and 1155 having a lighter (i.e., thinner) font than that of the page indicator 1152, so as to indicate a second page among a total of five pages as the page 1131.

FIGS. 11B, 11C, and 11D correspond to the continuously displayed screens when the user makes a user input in the first area 1131 of the screen 1100, that is, when the user drags the screen 1100 in a left direction.

According to an embodiment of the present disclosure, the processor 120 may control the display 150 to continuously change the page indicators 1151-1155 displayed in the second area 1132 according to a ratio between a display area of the part of the page 1131 and a display area of the part of the page 1132. For example, the processor 120 may control the display 150 to decrease the weight (i.e., line thickness or area) of the page indicator 1152 indicated by the English letter “B” as the display area of the page 1131 decreases, and simultaneously to increase the weight (i.e., line thickness or area) of the page indicator 1153 indicated by the English letter “C” as the display area of the page 1132 increases. In FIG. 11D, the processor 120 may make a control to display the page 1132 in the first area 1110. The processor 120 may control the display 150 to display the page indicator 1153 corresponding to the page 1132 with a thicker font (or with a large area) and display the other page indicators 1151, 1152, 1154, and 1055 more thinner font than that of the page indicator 1153 in the second area 1120.

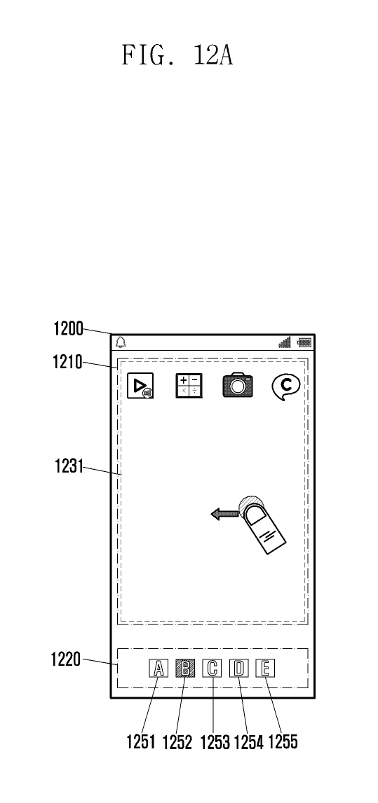

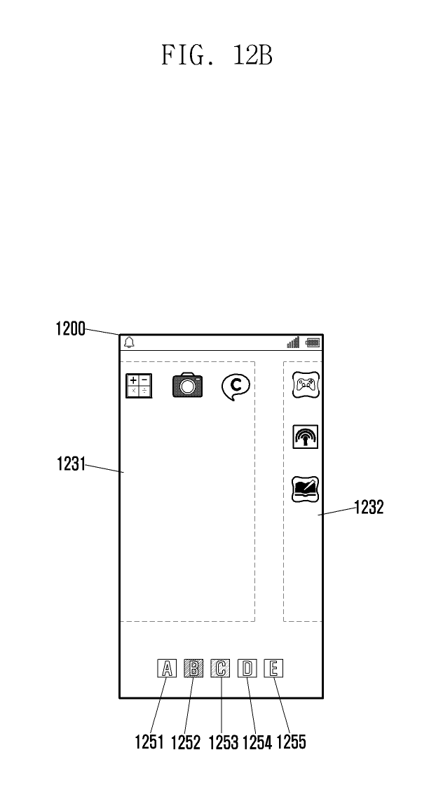

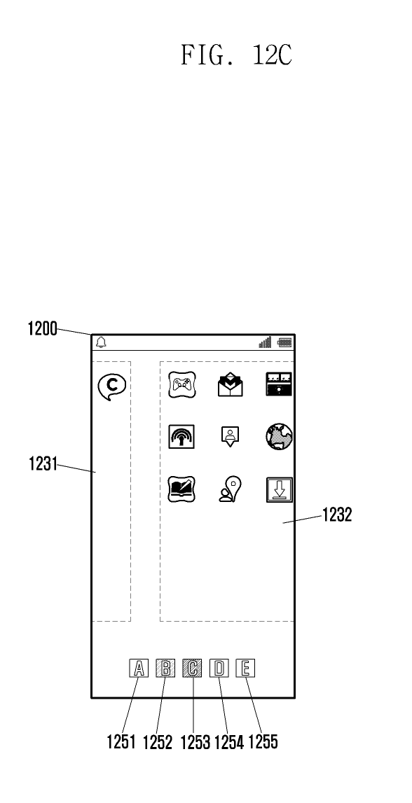

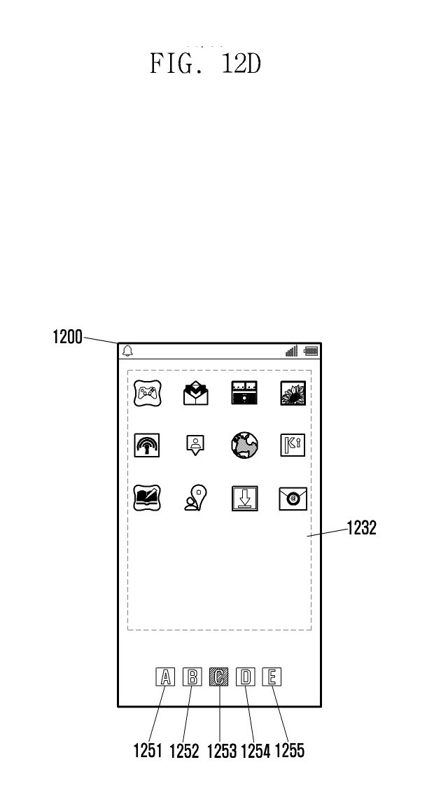

FIGS. 12A, 12B, 12C, and 12D illustrate an example for describing a method of displaying a GUI according to an embodiment of the present disclosure.

Referring to FIGS. 12A, 12B, 12C, and 12D, the processor 120 may control the display 150 to display a currently displayed page 1231 in a first area 1210 of a screen 1200 (for example, a menu screen) and display page indicators 1251-1255 in English letters in a second area 1220 on the screen 1200. The processor 120 may control the display 150 to display the page indicator 1252 in accordance with the page 1231. For example, when the page indicators 1251-1255 are English letters, the processor 120 may control the display 150 to display the page indicator 1252 with a predetermined color and display the remaining page indicators 1251, 1253, 1254, and 1255 with a color different from that of the page indicator 1252, so as to indicate a second page among a total of five pages as the page 1231.

FIGS. 12B, 12C, and 12D correspond to the continuously displayed screens when the user makes a user input in the first area 1210 of the screen 1200, that is, when the user drags the screen 1200 in a left direction.

According to an embodiment of the present disclosure, the processor 120 may control the display 150 to continuously change the page indicators 1251-1255 displayed in the second area 1220 according to a ratio between a display area of the part of the page 1231 and a display area of the part of the page 1232. For example, the processor 120 may control the display 150 to decrease a color depth of the page indicator 152 indicated by the English letter “B” as the display area of the page 1231 decreases, and simultaneously to increase a color depth of the page indicator 1253 indicated by the English letter “C” as the display area of the page 1232 increases. In FIG. 12D, the processor 120 may make a control to display the page 1232 in the first area 1210. The processor 120 may control the display 150 to display the page indicator 1253 corresponding to the page 1232 with a predetermined color and display the other page indicators 1251, 1252, 1254, and 1255, which are not displayed on the screen, with a different color from that of the page indicator 1253 in the second area 1220.

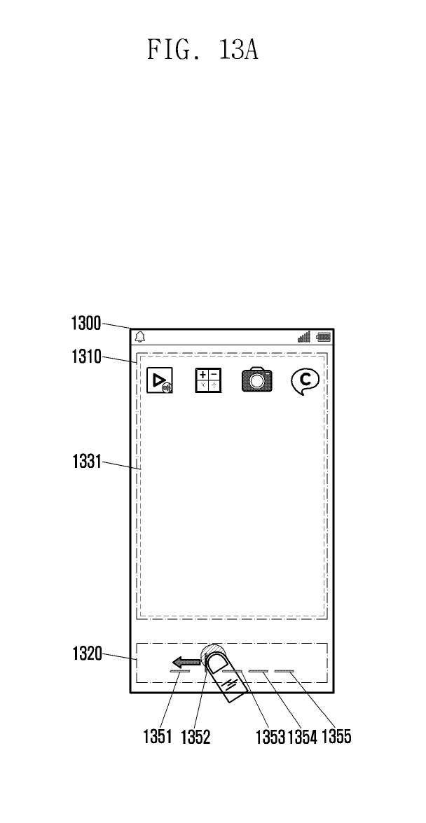

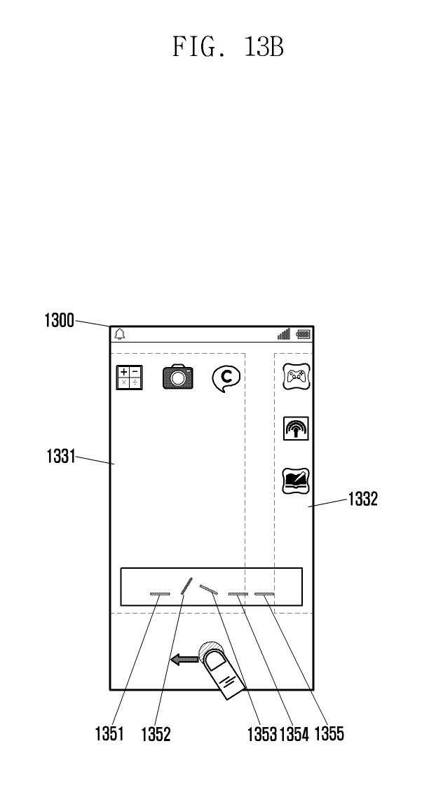

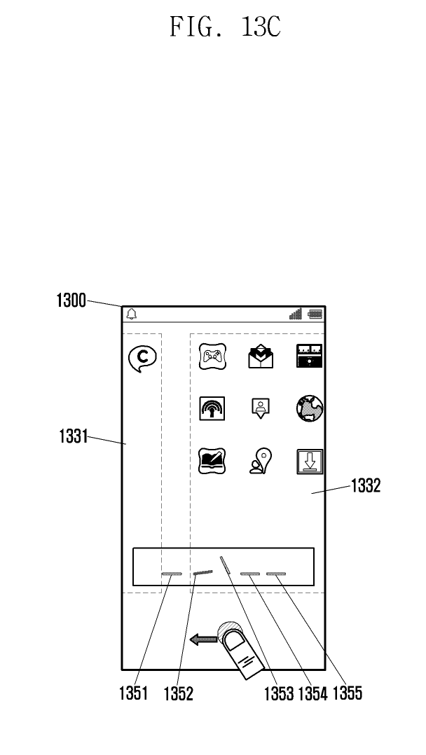

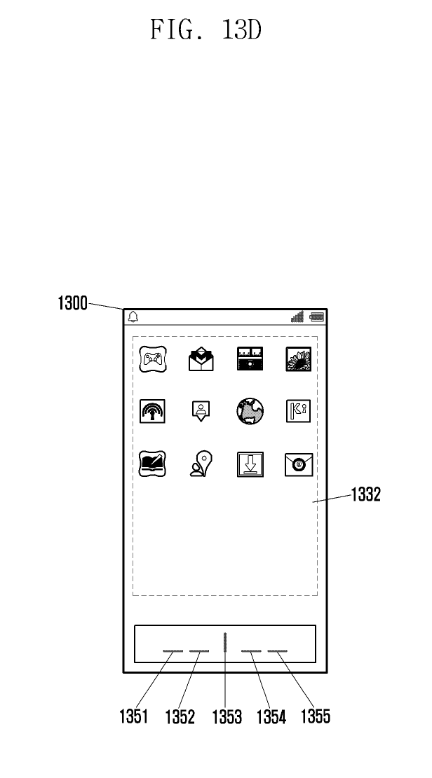

FIGS. 13A, 13B, 13C, and 13D illustrate an example for describing a method of displaying a GUI according to an embodiment of the present disclosure.

Referring to FIGS. 13A, 13B, 13C, and 13D, the processor 120 may control the display 150 to display a page 1331 in a first area 1310 of a screen 1300 (for example, a menu screen) and display page indicators 1351-1355 in a bar type in a second area 1320.

The processor 120 may control the display 150 to display the page indicator 1352 in accordance with the page 1331. For example, when the page indicators 1351-1355 are the bar type, the processor 120 may control the display 150 to vertically display the page indicator 1352 and horizontally display the remaining page indicators 1351, 1353, 1354, and 1355, so as to indicate a second page among a total of four pages as the page 1331.

FIG. 13B, 13C, and 13D correspond to the continuously displayed screens when the user makes a user input in the second area 1332 of the screen 1300, that is, when the user drags the screen 1300 in a left direction. As the page 1331 is switched in the left direction based on the user input, the processor 120 may control the display 150 to display a part of the page 1331 and a part of the page 1032 in FIGS. 13B and 13C.

According to an embodiment of the present disclosure, when a user input in the second area 1320 is received, the processor 120 may control to move the second area 1320 and the page indicators 1351-1355 displayed in the second area 1320. For example, when the user touches (for example, drags or flicks) the second area 1320 in a left direction in the screen 1300, the processor 120 may control the display 150 to move and display the second area 1320 and the page indicators 1351-1355 displayed in the second area 1320 as illustrated in FIGS. 13B, 13C, and 13D. According to an embodiment of the present disclosure, the processor 120 may control the display 150 to overlap, with the first area 1310, the page indicators 1351-1355 displayed in the moved and displayed first area 1310 and the second area 1320.

According to an embodiment of the present disclosure, the processor 120 may control the display 150 to continuously change the page indicators 1351-1355 displayed in the moved second area 1320 according to a ratio between a display area of a part of the page 1331 and a display area of a part of the page 1332. For example, in FIG. 13C, the processor 120 may control the display 150 to display the page indicator 1351 corresponding to the page 1331 at a slope smaller than that of the page indicator 1352 corresponding to the page 1331 displayed on FIG. 13B. In FIG. 13C, the processor 120 may control the display 150 to display the page indicator 1353 corresponding to the page 1332 at a slope larger than that of the page indicator 1353 corresponding to the page 1332 displayed on FIG. 13B.

In FIG. 13D, when the page switching is completed, the processor 120 may control the display 150 to return the second area 1320 of the screen to the original position and to vertically display the page indicator 1353 corresponding to the page 1332.

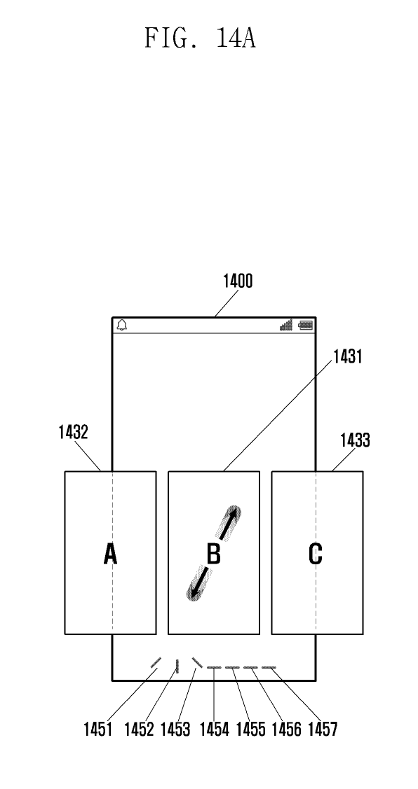

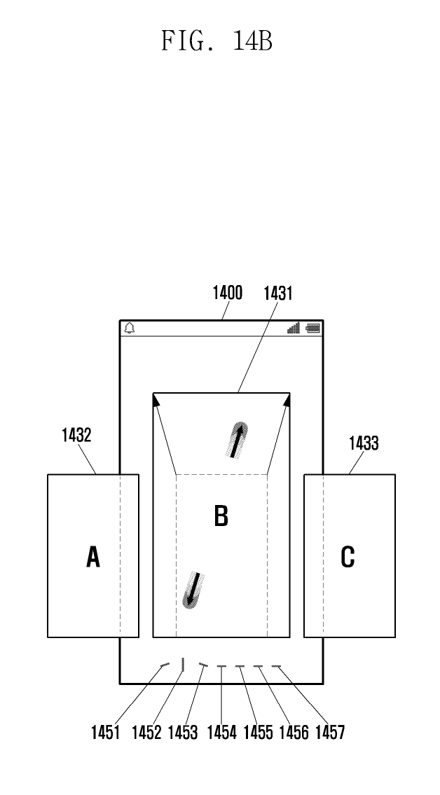

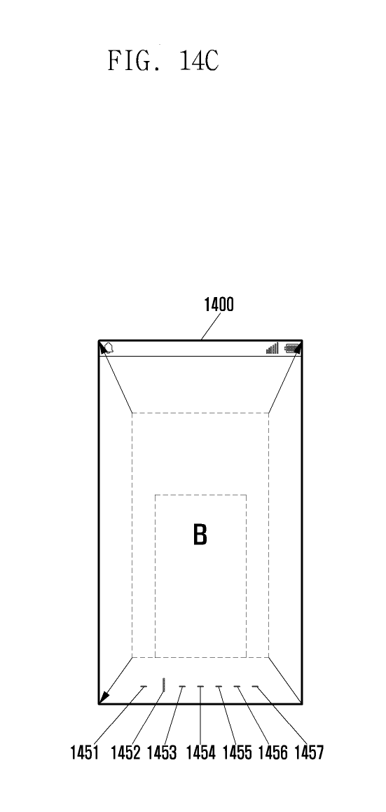

FIGS. 14A, 14B, and 14C illustrate an example for describing a method of displaying a GUI according to an embodiment of the present disclosure.

Referring to FIGS. 14A, 14B, and 14C, in a screen 1400, the processor 120 may control the display 150 to display at least a part of pages 1432 and 1433 adjacent to a page 1431, which is displayed in the middle of a screen 1400. In FIG. 14A, the processor 120 may control the display 150 to distinguish a page indicator 1452 corresponding to the page 1431 from page indicators 1451 and 1453-1457 corresponding to other pages. For example, in FIG. 14, the processor 120 may control the display 150 to vertically display the page indicator 1452 in the bar type corresponding to the page 1431 displayed in the middle of the screen. According to an embodiment of the present disclosure, the processor 120 may control the display 150 to change slopes of the page indicators 1451 and 1453 corresponding to the pages 1432 and 1433 in a predetermined direction and angle according to a ratio between a display area of the page 1431 and display areas of the pages 1432 and 1433.

According to an embodiment of the present disclosure, the processor 120 may control the display 150 to display continuously changed page indicators 1451, and 1453-1457 according to an area of the page 1431. For example, when the processor 120 receives a pinch zoom input in a direction of an arrow on the page 1431 of FIG. 14A, the processor 120 may control the display 150 to increase the area of the page 1431 and decrease lengths of the remaining page indicators 1451 and 1453-1457. However, the above description is only an example and does not limit the present disclosure. For example, the processor 120 may increase the length of the page indicator 1452 in the bar type and maintain the lengths of the remaining page indicators 1451, and 1453-1457 while enlarging and displaying the area of the page 1431. In another example, when the processor 120 receives a pinch zoom input in a direction of an arrow on the page 1431 of FIG. 14A, the processor 120 may control the display 150 to increase the display area of the page 1431 and decrease the display areas of the pages 1451 and 1453 adjacent to the page 1431. The processor 120 may control the display 150 to continuously change the page indicators 1451-1453, respectively, according to a ratio of the display area of the increased page 1431 and the display areas of the pages 1432 and 1433 that are adjacent to the page 1431.

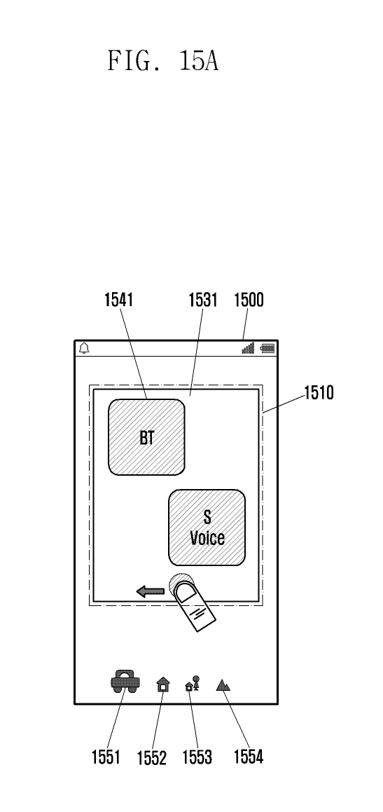

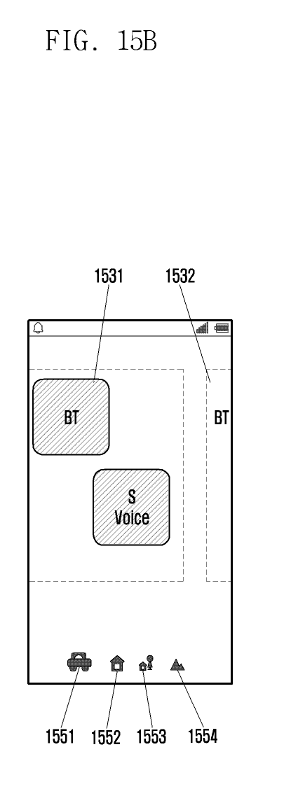

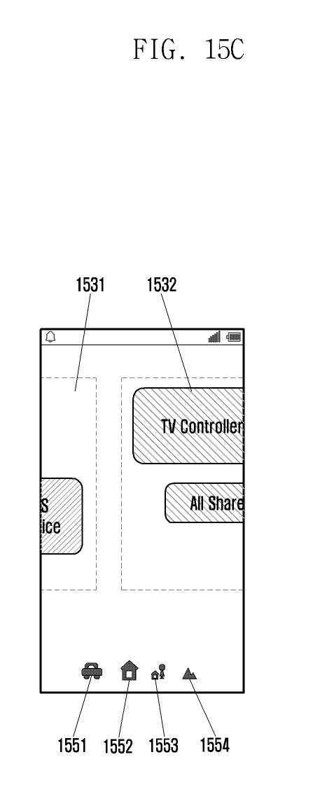

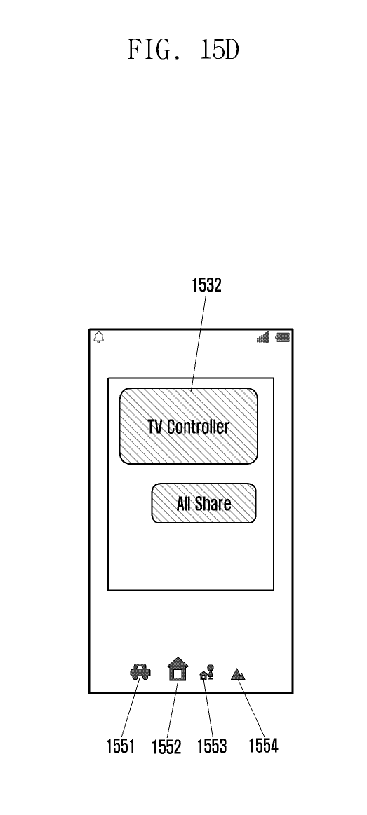

FIGS. 15A, 15B, 15C, and 15D illustrate an example for describing a method of displaying a GUI according to an embodiment of the present disclosure.

Referring to FIGS. 15A, 15B, 15C, and 15D, the processor 120 may control the display 150 to display various forms of page indicators 1551-1554 based on a characteristic of an object 1541 included in each of a plurality of pages. For example, when each of the plurality of pages includes an object corresponding to a category according to the category, the processor 120 may control the display 150 to display page indicators 1551-1554 corresponding to a category of each page. In FIG. 15A, for example, when there is an object 1541 related to a vehicle on the page 1531 in a first area 1510, the processor 120 may control the display 150 to display the page indicator 1551 in a vehicle form corresponding to the object 1541 related to the vehicle. In another example, when the page 1532 includes an object corresponding to an application, which is executed within the home (for example, a home network-related application, an application frequently used at the home, or the like), the processor 120 may display a house-shaped indicator. In FIG. 15A, when a user input is received, the processor 120 may control the display 150 to display the page indicators 1551-1554, which have sizes that are continuously changed according to a ratio between a display area of the page 1531 and a display area of the page 1532 as illustrated in FIGS. 15B, 15C, and 15D. In FIGS. 15B, 15C, and 15D, the processor 120 may control the display 150 to decrease the size of the page indicator 1551 and increase the size of the page indicator 1552. When the page, which is being displayed in a first area of the display 150, switches from the page 1531 to the page 1532, the processor 120 may control the display 150 to display an object corresponding to a category of the page 1532, for example, an object corresponding to an application executed within the home and display the page indicator 1552 in the house form corresponding to the object in FIG. 15D.

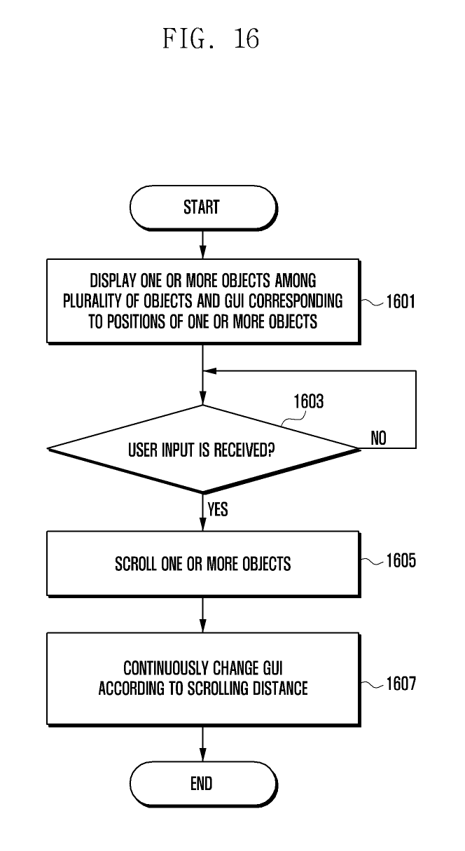

FIG. 16 is a flowchart illustrating a method of displaying a GUI according to an embodiment of the present disclosure.

Referring to FIG. 16, in operation 1601, the processor 120 may control the display 150 to display at least one of a plurality of objects in a first area of the screen and display a GUI corresponding to a position of at least one object in a second area. According to an embodiment of the present disclosure, the processor 120 may control to display at least one of a plurality of objects in a list form in the first area. However, the list form is only an example, and the processor 120 may control the display 150 to display an object (for example, picture) in various forms such as a thumbnail as well. Hereinafter, it is assumed that the object displayed in the first area is displayed in the list form for the convenience of the description.

According to an embodiment of the present disclosure, the GUI may be an object indicator displayed in accordance with at least one object displayed in the first area. For example, based on a predetermined position of the object in the first area of the currently displayed screen, the processor 120 may control the display 150 to distinguish an object indicator corresponding to the object arranged at the predetermined position from other object indicators. According to an embodiment of the present disclosure, the predetermined position may be the uppermost end of the first area. However, the present disclosure is not limited thereto, but the predetermined position may be the middle or bottom end of the first area and may be designated by user configuration. The processor 120 may control the display 150 to display an object indicator corresponding to an object arranged at a predetermined position at the same ratio as a position ratio of the object arranged at the predetermined position of the first area on the screen. For example, when an object displayed at a predetermined position, for example, an uppermost end of the first area corresponds to a sixth object among a total of twenty objects included in an object list and ten object indicators are included in a second area, the processor 120 may control the display 150 to distinguish a third object indicator as an object indicator corresponding to the object displayed at the uppermost end of the first area from other object indicators.

In another example, when objects displayed in the first area are classified according to a group, the processor 120 may control the display 150 to distinguish, according to a group including an object displayed at a predetermined position, an object indicator corresponding to the corresponding group from other object indicators.

In another example, when objects displayed in the first area are classified according to each page, the processor 120 may control the display 150 to distinguish an object indicator corresponding to each page from other object indicators.

According to an embodiment of the present disclosure, the processor 120 may control the display 150 to display the object indicator in various forms. For example, the processor 120 may control the display 150 to display the page indicator in the form of a bar, a polygon having an area, an English letter, or a number.

According to an embodiment of the present disclosure, in order to distinguish an object indicator corresponding to an object arranged at a predetermined position included in the first area, a group, or a page from other object indicators, the processor 120 may control the display 150 to display the corresponding object indicator with at least one of a size, thickness, color, and shade (or depth) of a color different from those of other object indicators.

In operation 1603, the processor 120 may identify whether a user input is received for at least one of the first area and the second area. For example, when the user touches, for example, drags or flicks at least one of the first area and the second area to scroll the object displayed on the screen, an event corresponding to the drag or flick may be received. For example, the processor 120 may receive a hard (or physical) key (or button) of the electronic device or a soft key (or virtual key) displayed on the display 150 and scroll the object displayed on the screen. In another example, the processor 120 may receive a signal from the external electronic device 104 or the server 106 and control the screen. When the user input is not received in operation 1603, the processor 120 may display an object or a GUI corresponding to the object, for example, an object indicator until the user input is received.

In operation 1605, the processor 120 may scroll at least one object displayed in the first area based on a received screen control input.

In operation 1607, the processor 120 may continuously change a GUI displayed in the second area according to a size (or distance) of scrolling of at least one object. For example, based on a predetermined position of the object (referred to as a “first object”) currently displayed in the first area, when an object indicator corresponding to the first object is distinguished from other object indicators, the processor 120 may control the display 150 to continuously change the object indicator according to a ratio between a distance between a position of the first object and a second object. For example, it is assumed that an object displayed at the uppermost end of the first area, which is the predetermined position, corresponds to a sixth object among a total of twenty objects included in the object list and the second area includes ten object indicators. The processor 120 may control the display 150 to distinguish a third object indicator, as an object indicator corresponding to an object displayed at the upper most of the first area, from other object indicators. An object corresponding to a fourth object indicator, as an object indicator adjacent to the third object indicator, may be an object located at an eighth position in the object list. When the user scrolls the object, the processor 120 may control the display 150 to continuously change the third object indicator and the fourth object indicator at the same ratio as that between a distance between a sixth object and an eighth object and a scrolling distance.

According to an embodiment of the present disclosure, when objects displayed in the first area are classified and displayed according to a group, the processor 120 may control the display 150 to change the object indicator based on a scrolling direction according to a ratio between a distance between a last or first object of a group and a first or last object of an adjacent group and the predetermined position. According to an embodiment of the present disclosure, when the object displayed at the predetermined position is included in the same group, the processor 120 may not change the form of the object indicator.

According to an embodiment of the present disclosure, when objects displayed in the first area are classified and displayed according to a page, the processor 120 may control the display 150 to change the object indicator according to a ratio between a display area of a page including an object currently displayed at a predetermined position and a display area of an adjacent page based on a scrolling direction.

According to an embodiment of the present disclosure, the processor 120 may control the display 150 to display the form of the object indicator, which is continuously changed, according to a user input. The processor 120 may control the display 150 to display the form of the page indicator, which is continuously changed, based on a speed, intensity, or pressure of the user input. For example, when the page indicator is the bar type, if the user inputs a drag by touching the screen with a user's finger at a fast speed, the processor 120 may control the display 150 to display the bar having a smaller slope compared to a case where the input is made at a slow speed or also continuously change forms of the other object indicators except for the corresponding object indicator.

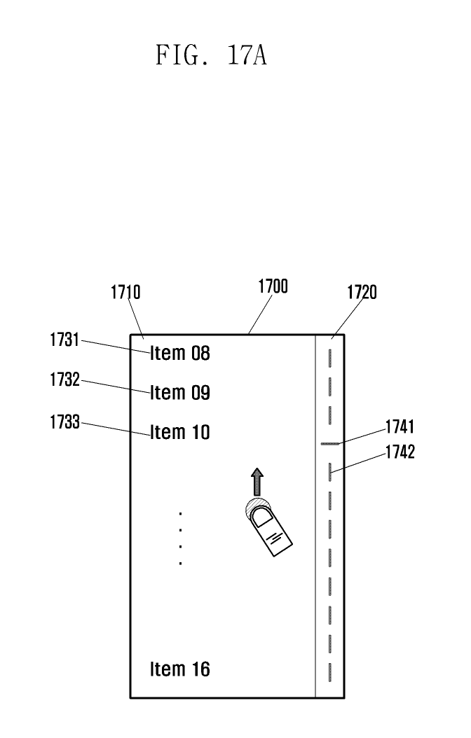

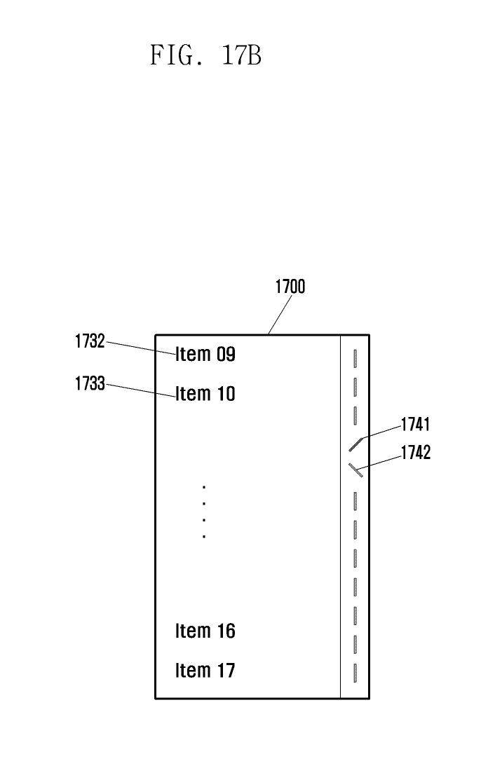

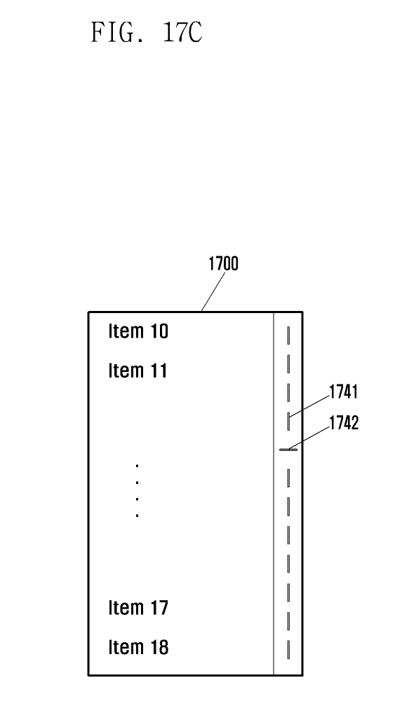

FIGS. 17A, 17B, and 17C illustrate an example for describing a method of displaying a GUI according to an embodiment of the present disclosure.

Referring to FIGS. 17A, 17B, and 17C, the processor 120 may control the display 150 to display one or more objects 1731-1733 in a first area 1710 and display object indicators corresponding to the one or more objects in a second area 1720 in FIG. 17A. The processor 120 may control the display 150 to horizontally display an object indicator 1741 in a bar type corresponding to the object 1731 located at the uppermost end of the first area as a predetermined position. However, the present disclosure is not limited thereto. For example, the predetermined position may be the middle or the bottommost end of the first area. In FIG. 17A, when an object 1731 corresponds to an object indicator 1741, an object 1733 may correspond to an object indicator 1742. For example, when there are a total of 24 objects and a total of 12 object indicators, if an eighth object 1731 corresponds to the object indicator 1741, a tenth object 1733 may correspond to the object indicator 1742.

In FIG. 17A, when the user drags a first area 1710 or a second area 1720 in an upward direction, the processor 120 may control the display 150 to scroll objects displayed in the first area 1710 in the up direction. As the objects are scrolled in the upward direction, the processor 120 may control the display 150 to continuously tilt the object indicator 1741 from a horizontal position thereof and simultaneously continuously tilt the object indicator 1742 from a vertical position thereof For example, referring to a comparison between FIGS. 17A and 17B, he processor 120 may control the display 150 to tilt the object indicator 1741 at 45 degrees from the horizontal position and tilt the object indicator 1742 at 45 degrees from the vertical position based on a ratio between a distance between the object 1731 corresponding to the object indicator 1741 and the object 1733 corresponding to the object indicator 1742 and a scrolling distance, that is, a distance between the object 1731 and the object 1732. In FIG. 17C, when the object 1733 is located at the predetermined position, the processor 120 may control the display 150 to vertically display the object indicator 1741 and horizontally display the object indicator 1742.

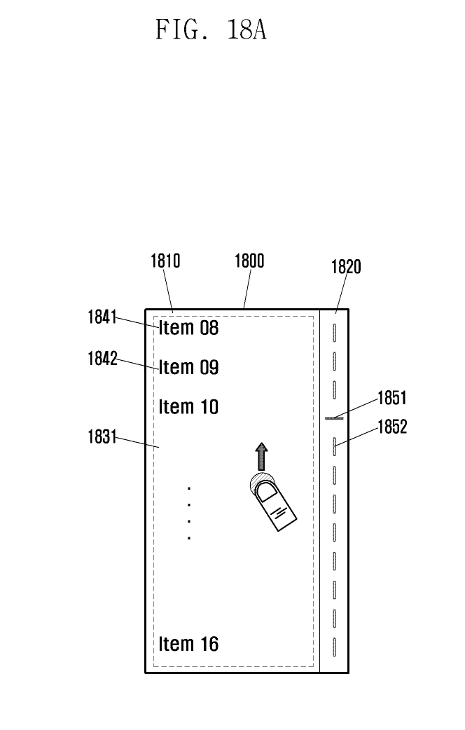

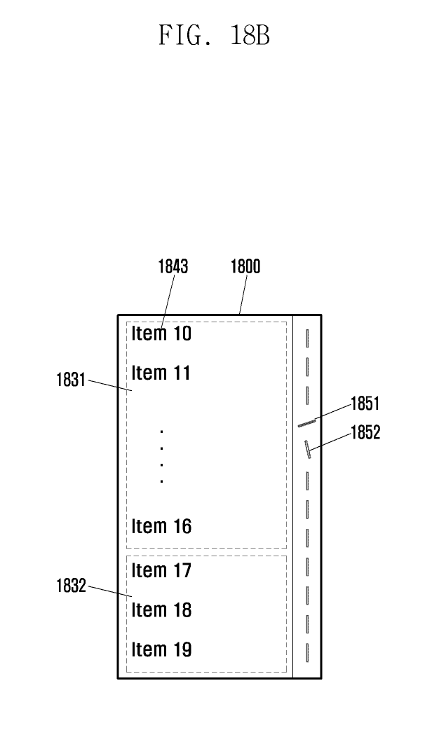

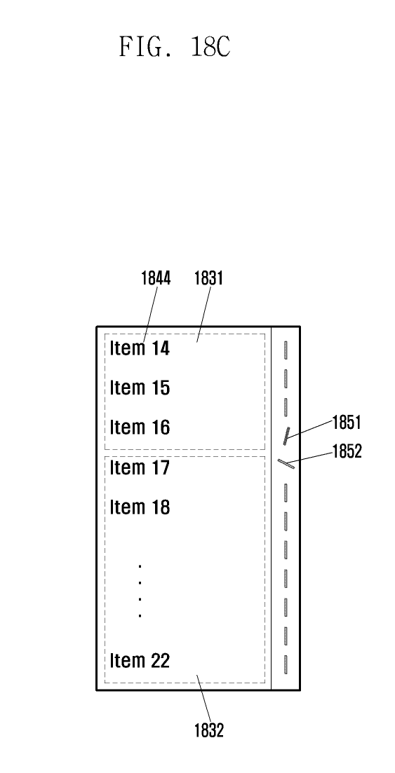

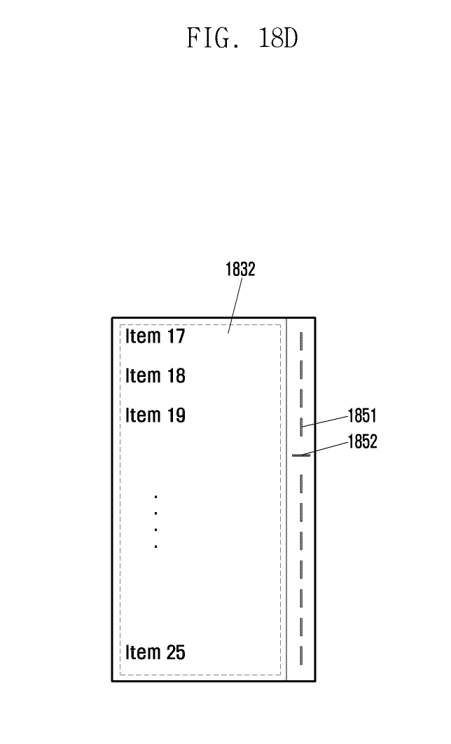

FIGS. 18A, 18B, 18C, and 18D illustrate an example for describing a method of displaying a GUI according to an embodiment of the present disclosure.

Referring to FIGS. 18A, 18B, 18C, and 18D, illustrated in a continuous change in object indicators as an object is scrolled when objects are classified and displayed according to each page. In FIG. 18A, the processor 120 may control the display 150 to display one or more objects 1841 and 1842 for each page in a first area 1810 and display object indicators corresponding to pages in a second area 1820. In FIG. 18A, the processor 120 may control to display objects included in a page 1831 in the first area 1810. For example, when the processor 120 receives an input of dragging the screen in an up direction, the processor 120 may control the display 150 to display continuously changed object indicators 1851 and 1852 according to a ratio between a display area of at least a part of the page 1831 and a display area of at least a part of the page 1832 as illustrated in FIGS. 18B and 18C. For example, as the page 1831 and the page 1832 are scrolled in the upward direction, the processor 120 may control the display 150 to continuously vertically tilt the object indicator 1851 from the horizontal position and simultaneously horizontally tilt the object indicator 1852 from the vertical position. In FIG. 18D, the processor 120 may control the display 150 to display the page 1832 and horizontally display the object indicator 1852 corresponding to the page 1832.

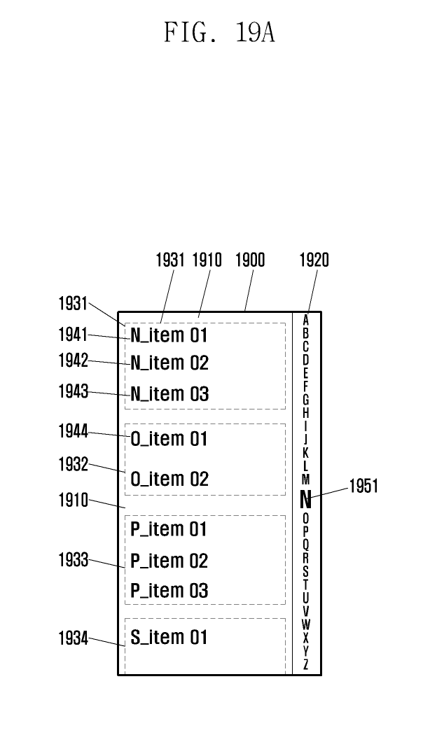

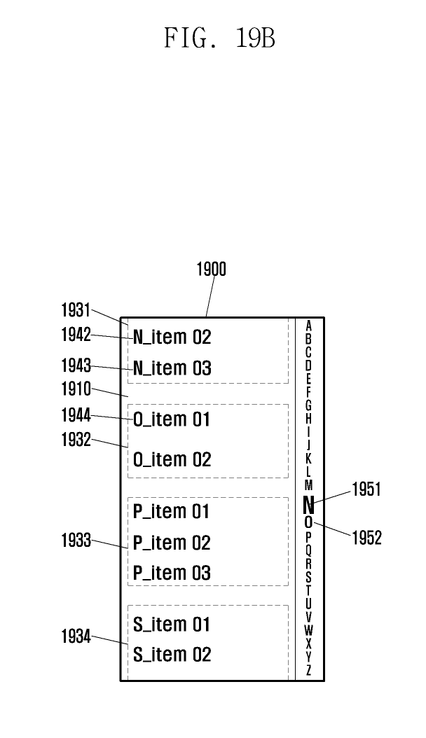

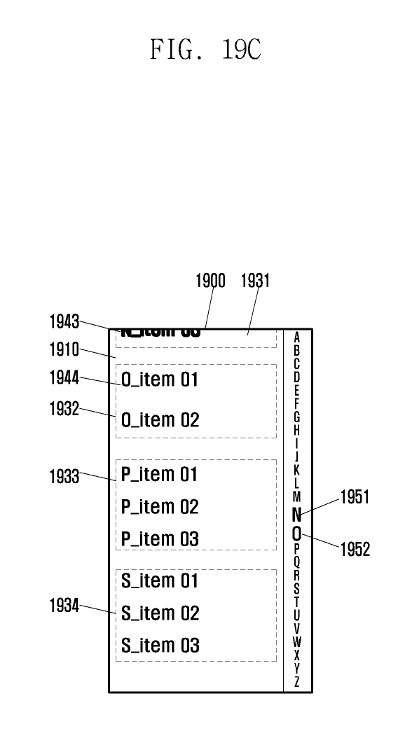

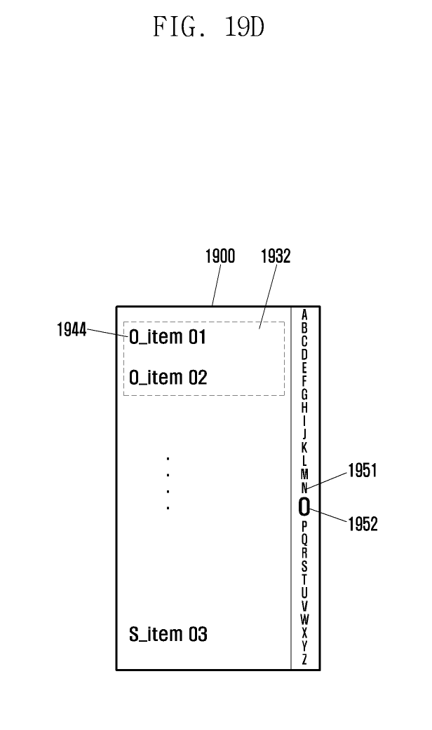

FIGS. 19A, 19B, 19C, and 19D illustrate an example for describing a method of displaying a GUI according to an embodiment of the present disclosure.

Referring to FIGS. 19A, 19B, 19C, and 19D, a continuous change in object indicators as an object is scrolled when objects are classified and displayed according to each group is illustrated. In FIG. 19A, the processor 120 may control the display 150 to display one or more objects according to groups 1931-1934 in a first area 1910 and display object indicators corresponding to the groups in a second area 1920. According to an embodiment of the present disclosure, to distinguish an object indicator 1951 corresponding to a group including an object 1941 located at a predetermined position (for example, the uppermost end of the first area) from other object indicators, the processor 120 may control the display 150 to display the object indicator 1951 in a larger size. In FIG. 19A, the object indicator 1951 corresponding to the group 1931 is displayed in a larger size than the other object indicators. Referring to a comparison between FIGS. 19A and 19B, when the user scrolls the object in an upward direction of the screen and an object 1942 included in the group 1931 is located at a predetermined position (for example, the uppermost end of the first area), the processor 120 may make not change the object indicator since the object 1942 is still located at the uppermost end of the first area. Referring to a comparison between FIG. 19B and 19C, the processor 120 may control the display 150 to continuously change the object indicator 1951 and the object indicator 1952 according to a ratio based on a distance between a last object 1943 in group 1931 and a predetermined position and a distance between a first object 1944 included in a group 1932 and the predetermined position. When the object 1944 included in the group 1932 is displayed at the predetermined position, the processor 120 may control the display 150 to display only an object indicator 1952 in a large size and display the object indicator 1951 with the same size as the other object indicators.

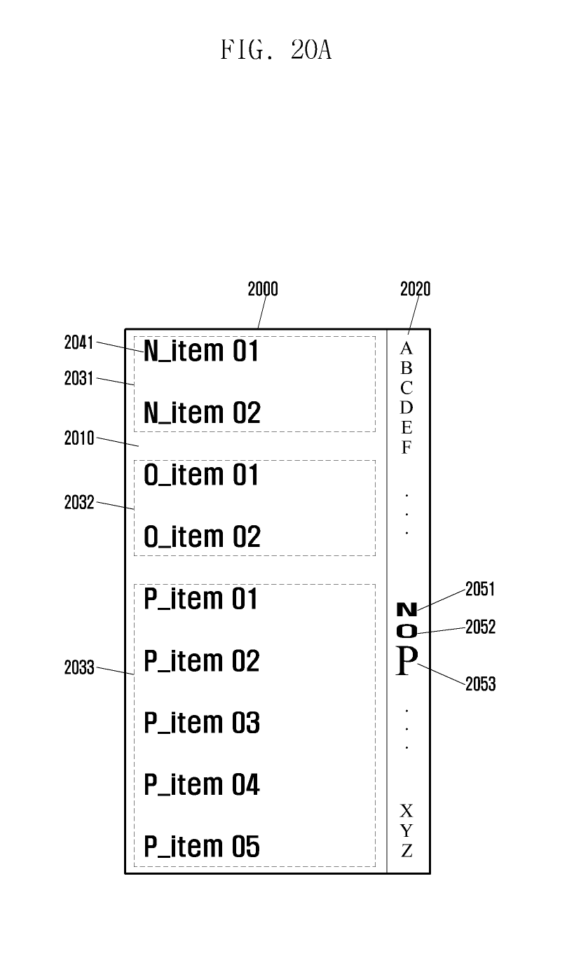

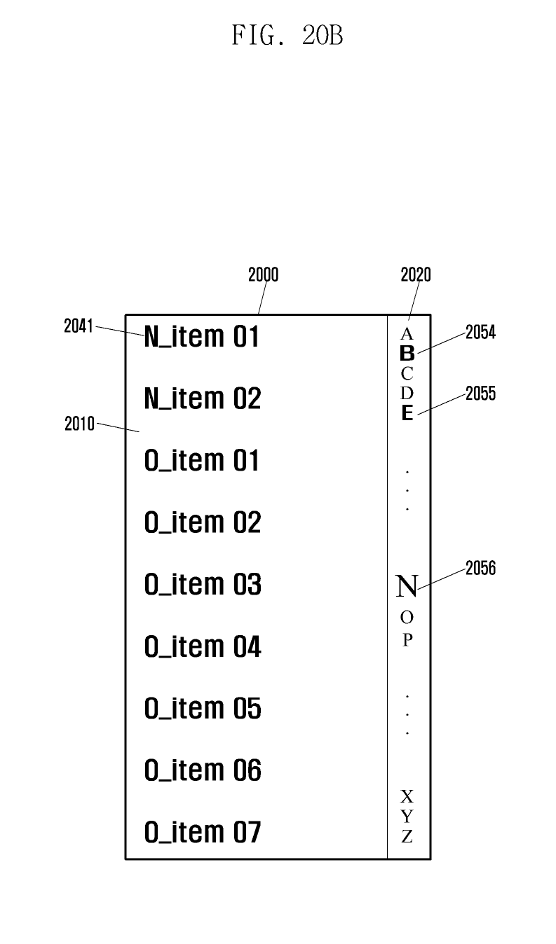

FIGS. 20A and 20B illustrates an example for describing a method of displaying a GUI according to an embodiment of the present disclosure. FIG. 20 illustrates a method of variously displaying object indicators based on a characteristic of an object.

Referring to FIGS. 20A and 20B, in FIG. 20A, the processor 120 may control the display 150 to display one or more objects according to each of the groups 2031-2033 in a first area 2010 and display object indicators corresponding to the groups in a second area 2020. According to an embodiment of the present disclosure, in order to distinguish an object indicator 2051 corresponding to a group including an object 2041 located at a predetermined position, for example, the uppermost end of the first area, from other object indicators, the processor 120 may control the display 150 to display the object indicator 2051 with a heavier weight (i.e., line thickness) than other object indicators 2052 and 2053. In FIG. 20A, the object indicator 2051 corresponding to the group 2031 is displayed with a heavier weight than the object indicators 2052 and 2053. According to an embodiment of the present disclosure, the processor 120 may control the display 150 to display object indicators according to a characteristic of a group, for example, the number of objects included in the group. For example, when the group 2031 includes two objects, the group 2032 includes three objects, and the group 2033 includes five objects, the processor 120 may control the display 150 to display the sizes of the object indicator 2051, the object indicator 2052, and the object indicator 2053 corresponding to the group 2031, the group 2032, and the group 2033, respectively, at a ratio of 2:2:5.

In FIG. 20B, the processor 120 may control the display 150 to display one or more objects in the first area 2010 and display object indicators in the second area 2020. In FIG. 20B, the processor 120 may control the display 150 to display an object indicator 2056 corresponding to the object 2041 displayed at a predetermined position, for example, the uppermost end of the first area in a larger size than those of other object indicators. According to an embodiment of the present disclosure, the processor 120 may leave a bookmark in one or more objects and display an object indicator corresponding to the displayed object differently from other object indicators. For example, the processor 120 may control the display 150 to display the object indicators 2054 and 2055 corresponding to the object having the bookmark with a heavier weight (i.e., a thicker line) than other object indicators. However, the present disclosure is not limited thereto, and the object indicator may be variously displayed according to a characteristic of the object. For example, the processor 120 may control the display 150 to display the object indicator with a different size, color, thickness and the like according to a capacity of the object (for example, a file) displayed in the first area.

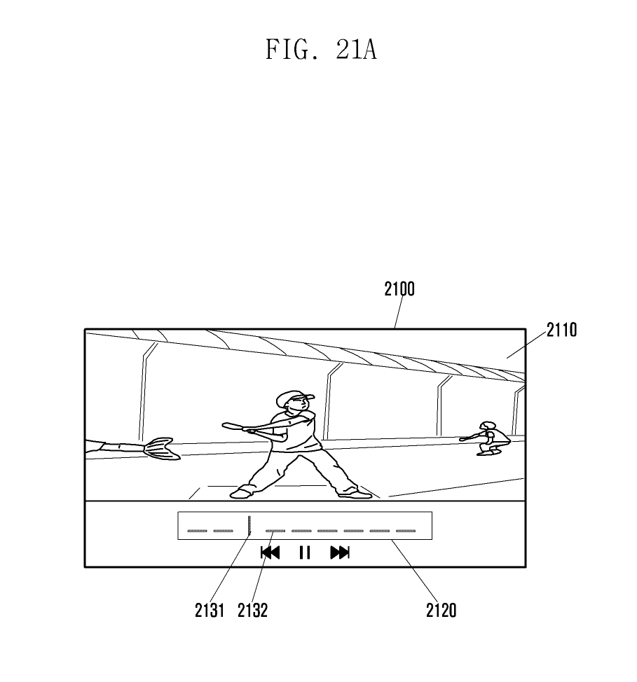

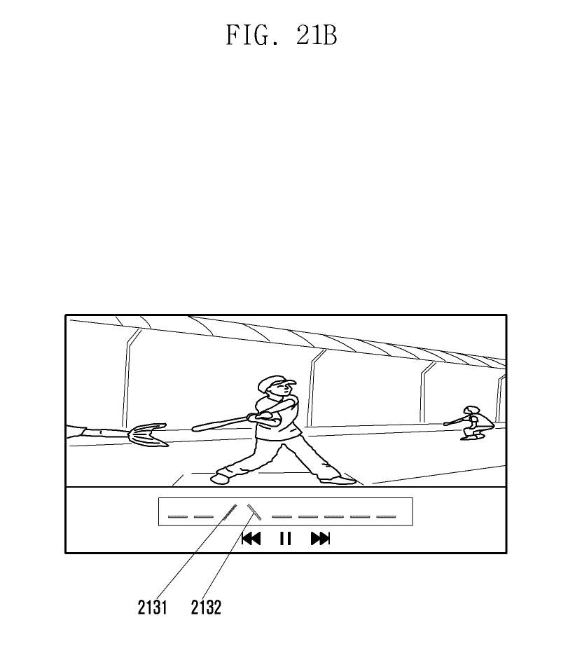

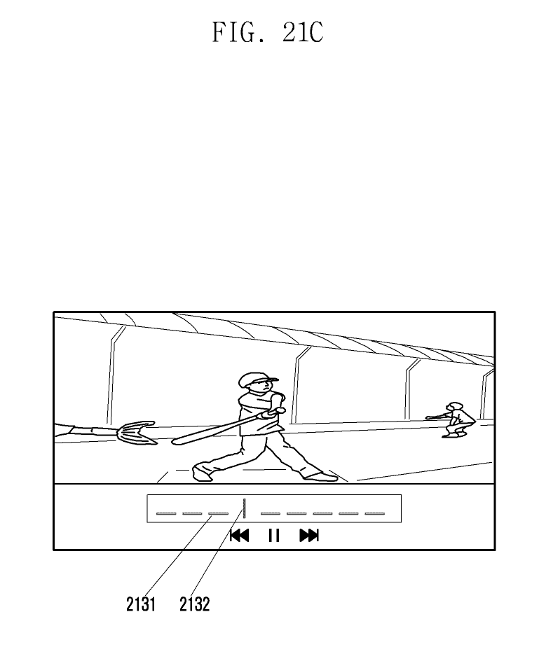

FIGS. 21A, 21B, and 21C illustrate an example for describing a method of displaying a GUI according to an embodiment of the present disclosure.

Referring to FIGS. 21A, 21B, and 21C, in FIG. 21A, the processor 120 may control the display 150 to reproduce an object (for example, content) in a first area 2110 of FIG. 21A and display indicators 2131 and 2132 to indicate information corresponding to a reproduction time of an object, which is being reproduced on the screen, in a second area 2120. Referring to a comparison FIGS. 21A, 21B, and 21B, as the object is reproduced, the processor 120 may control the display 150 to continuously change slopes of the indicators 2131 and 2132 in a bar type. For example, as the object is reproduced, the processor 120 may control the display 150 to change the slope of the indicator 2131 gradually from a vertical position to a horizontal position and simultaneously change the slope of the indicator 2132 gradually from a horizontal position to a vertical position.

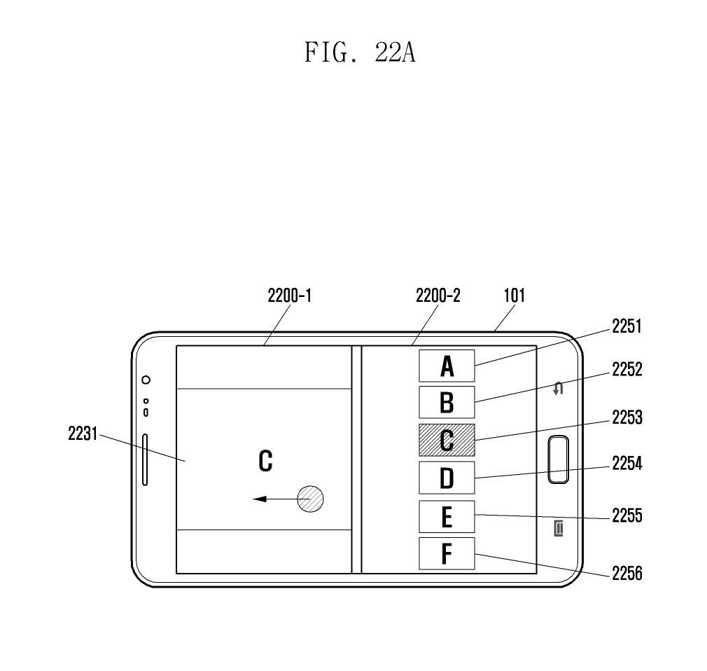

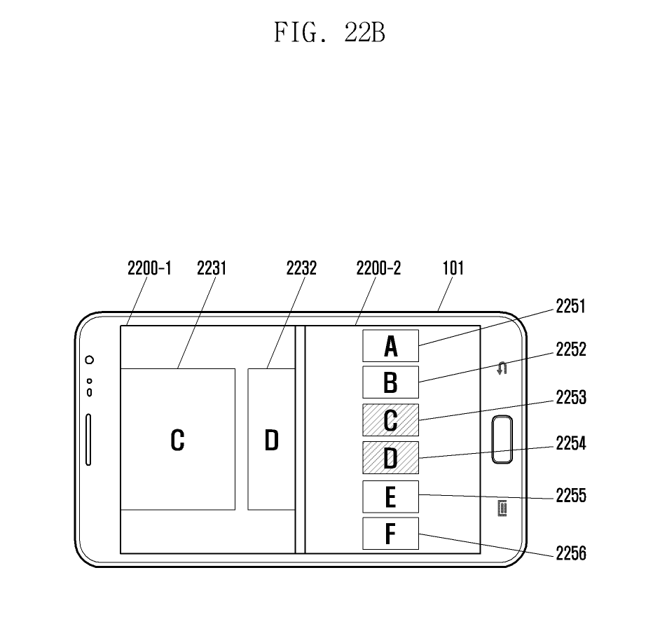

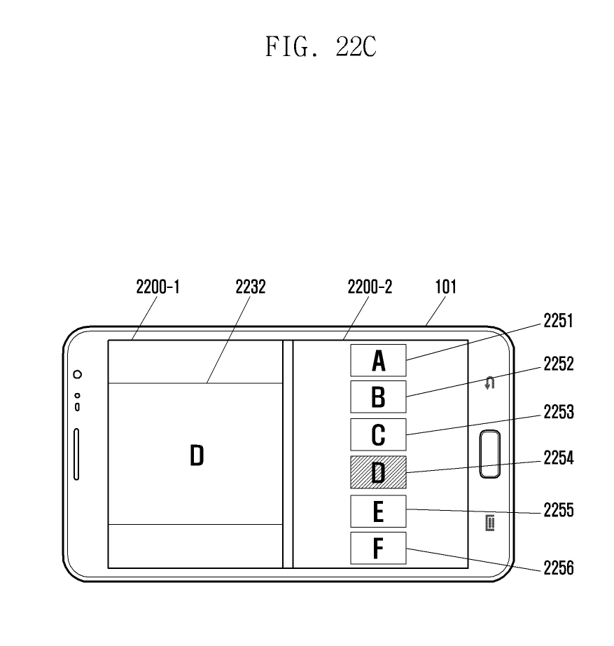

FIGS. 22A, 22B, and 22C illustrates an example for describing a method of displaying a GUI according to an embodiment of the present disclosure.

Referring to FIGS. 22A, 22B, and 22C, when the electronic device is a dual display electronic device having two displays 2200-1 and 2200-2, the processor 120 may control the display to display at least some of a plurality of pages including a page 2231 on one of the two displays 2200-1 and 2200-2 and display page indicators 2251-2256 on the other display.

In FIG. 22A, the processor 120 may make a control to display the page on the display 2200-1 and display the page indicators 2251-2256 on the display 2200-2. In FIG. 22A, when the processor 120 receives a touch input (for example, a drag or flick) on the display 2200-1, the processor 120 may control to display a state where the page is being switched on the display 2200-1 and display the continuously changed page indicators 2251-2256 corresponding to the page on the display 2200-2. For example, the processor 120 may control to continuously change color depths of the page indicators 2253 and 2254 on the display 2200-2 according to a ratio between areas of the pages displayed on the display 2200-1.

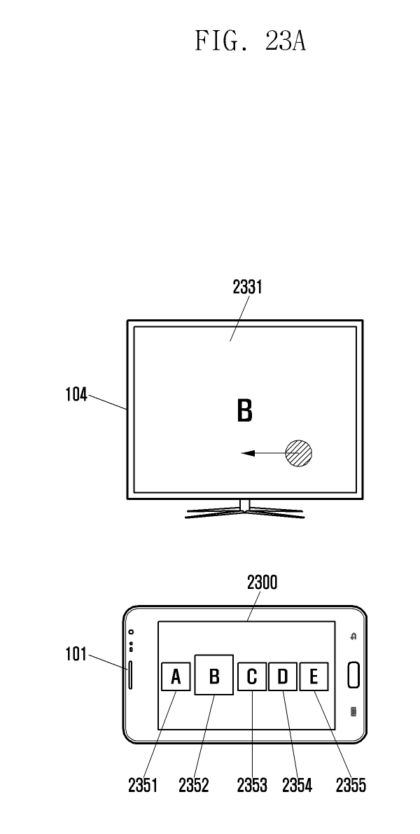

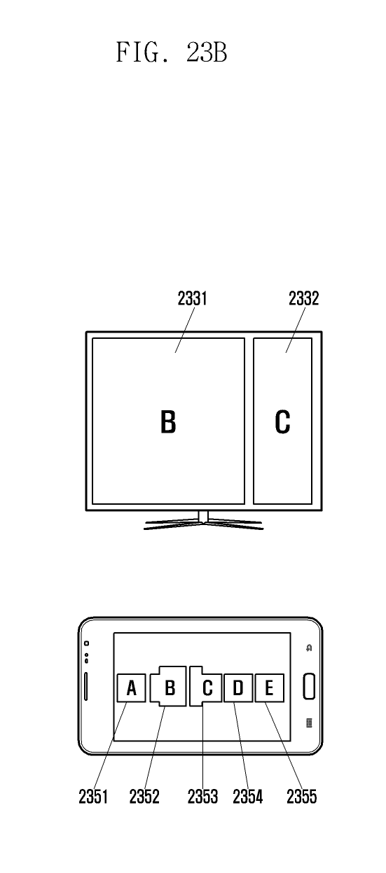

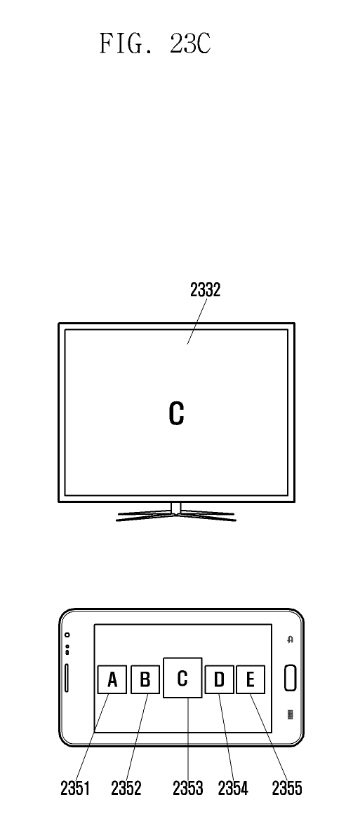

FIGS. 23A, 23B, and 23C illustrate an example for describing a method of displaying a GUI according to an embodiment of the present disclosure.

Referring to FIGS. 23A, 23B, and 23C, the electronic device 101 may display a GUI through an interworking with the electronic device 104. For example, in FIG. 23A, the electronic device 104 may display a page 2331 and the electronic device 101 may display page indicators 2351-2355. In FIG. 23A, when the electronic device 104 receives a touch input (for example, a drag or flick), the electronic device 101 may control the electronic device 104 to display a page is being changed and control to display the changed page indicators 2352 and 2353 corresponding to the page switching as illustrated in FIGS. 23B and 23C. For example, the electronic device 101 may make a control to continuously change areas of the page indicators 2352 and 2353 on the screen of the electronic device 101 according to a ratio between display areas of pages 2331 and 2332 displayed in the electronic device 104.

According to various embodiments of the present disclosure, a method of displaying a GUI by an electronic device may include displaying a first page among a plurality of pages and the GUI corresponding to the first page on a screen, displaying at least a part of the first page and at least a part of a second page adjacent to the first page among the plurality of pages based on a user input received in at least one of an area in which the first page is displayed and an area in which the GUI is displayed, and continuously changing the displayed GUI according to a ratio between an area of at least the part of the displayed first page and an area of at least the part of the displayed second page.

According to various embodiments of the present disclosure, the GUI may include page indicators.

According to various embodiments of the present disclosure, the continuous changing of the displayed GUI may include continuously changing at least one of a size, slope, color, color depth, thickness, and area of the page indicator.

According to various embodiments of the present disclosure, the method may further include: inserting a third page or removing the first page; and, when the third page is inserted or the first page is removed, continuously changing the page indicator.

According to various embodiments of the present disclosure, the continuous changing of the displayed GUI may further include continuously changing the page indicator based on at least one of a speed, intensity, and pressure of the received user input.

According to various embodiments of the present disclosure, the method may further include: increasing or decreasing an area of the first page in a state where the first page is displayed in the middle of the screen; and, when the area of the first page is increased or decreased, continuously changing the page indicator.

According to various embodiments of the present disclosure, the continuous changing of the displayed GUI may further include continuously changing the page indicator in a different way according to a page switching type.

According to various embodiments of the present disclosure, the continuous changing of the displayed GUI may further include, when the user input is received, moving the page indicator displayed in the area to another area and displaying the page indicator in the moved area.

According to various embodiments of the present disclosure, the page indicator may be differently displayed according to a characteristic of an object included in each of the plurality of pages.

According to various embodiments of the present disclosure, the electronic device may further include one or more screens, and the screen and the one or more screens may display the first page and the GUI, respectively.

According to various embodiments of the present disclosure, the screen and a screen of another electronic device may display the first page and the GUI through an interworking with the other electronic device.

According to various embodiments of the present disclosure, a method of displaying a GUI by an electronic device may include: displaying one or more of a plurality of objects and the GUI corresponding to the one or more objects on a screen; scrolling the one or more objects based on a user input received in at least one of an area in which the one or more objects are displayed and an area in which the GUI is displayed; and continuously changing the GUI according to a scrolling distance of the one or more objects.

According to various embodiments of the present disclosure, the method may further include continuously changing the GUI including one or more object indicators.

According to various embodiments of the present disclosure, the continuous changing of the GUI may include continuously changing at least one of a size, slope, color, color depth, thickness, and area of the one or more object indicators.

According to various embodiments of the present disclosure, the continuous changing of the GUI may further include continuously changing the one or more object indicators according to a group or a page including the one or more objects.

According to various embodiments of the present disclosure, when the one or more objects correspond to contents, the method may further include: reproducing the contents; and continuously changing the GUI in accordance with time information on reproduction of the contents.

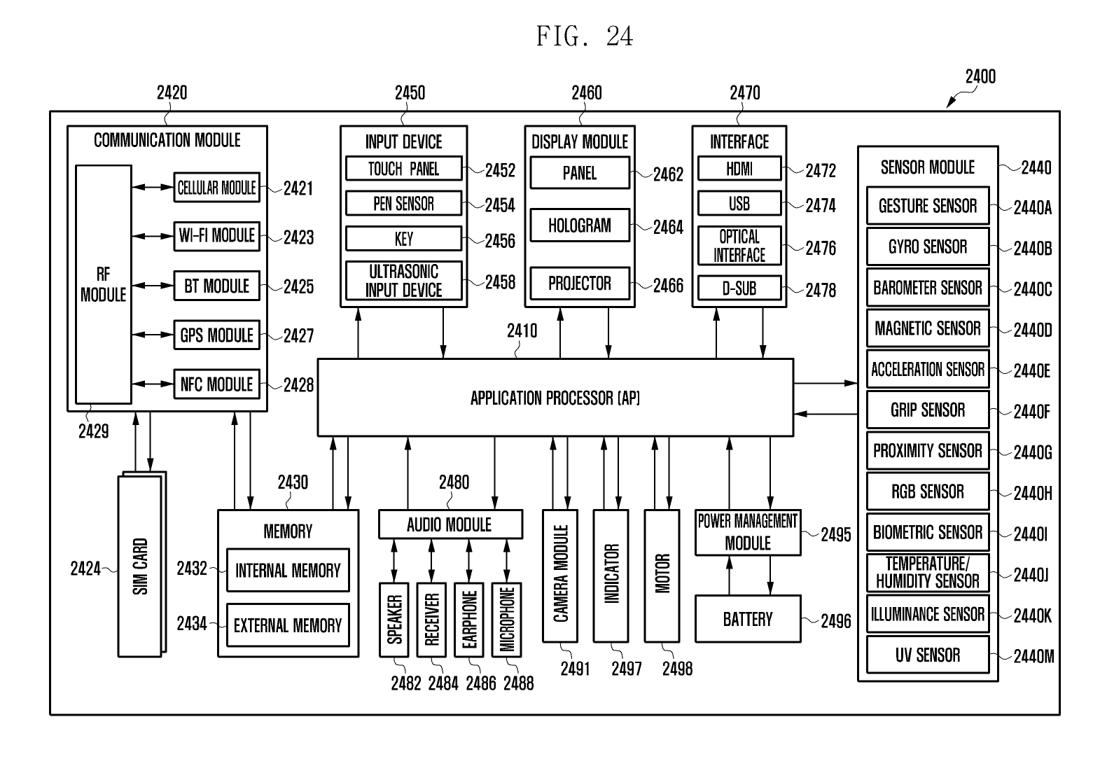

FIG. 24 is a block diagram illustrating a configuration of hardware according to an embodiment of the present disclosure.

Referring to FIG. 24, hardware 2400 may be, for example, the electronic device 101 illustrated in FIG. 1. As illustrated in FIG. 24, the hardware 2400 may include one or more application processors (APs) 2410, a subscriber identification module (SIM) card 2424, a communication module 2420, a memory 2430, a sensor module 2440, an input module 2450, a display module 2460, an interface 2470, an audio module (e.g., audio coder/decoder (codec)) 2480, a camera module 2491, a power management module 2495, a battery 2496, an indicator 2497, a motor 2498 and any other similar and/or suitable components.

The AP 2410 (e.g., the processor) may include one or more APs, or one or more communication processors (CPs).

The AP 2410 may execute an operating system (OS) or an application program, and thereby may control multiple hardware or software elements connected to the AP 2410 and may perform processing and arithmetic operations on various data including multimedia data. The AP 2410 may be implemented by, for example, a system on chip (SoC). According to various embodiments of the present disclosure, the AP 2410 may further include a graphical processing unit (GPU) (not illustrated).

The SIM card 2424 may be a card implementing a SIM, and may be inserted into a slot formed in a particular portion of the electronic device 100. The SIM card 2424 may include unique identification information (e.g., integrated circuit card identifier (ICCID)) or subscriber information (e.g., international mobile subscriber identity (IMSI)).

The communication module 2420 may be, for example, the communication module 160 illustrated in FIG. 1. The communication module 2420 may include a radio frequency (RF) module 2429. The communication module 2420 may further include, for example, a cellular module 2421, a Wi-Fi module 2423, a BT module 2425, a GPS module 2427, and an NFC module 2428. For example, the communication module 2420 may provide a wireless communication function by using a radio frequency. Additionally or alternatively, the communication module 2420 may include a network interface (e.g., a local area network (LAN) card), a modulator/demodulator (modem), and/or the like for connecting the hardware 2400 to a network (e.g., the Internet, a LAN, a wide area network (WAN), a telecommunication network, a cellular network, a satellite network, a POTS, and/or the like).

The cellular module 2421 may further include a CP. The CP may control the transmission and reception of data by the communication module 2420. As illustrated in FIG. 24, the elements such as the CP, the power management module 2495, the memory 2430, and the like are illustrated as elements separate from the AP 2410. However, according to various embodiments of the present disclosure, the AP 2410 may include at least some (e.g., the CP) of the above-described elements. The CP may manage a data line and may convert a communication protocol in the case of communication between the electronic device (e.g., the electronic device 100) including the hardware 200 and different electronic devices connected to the electronic device through the network.

The RF module 2429 may be used for transmission and reception of data, for example, transmission and reception of RF signals or called electronic signals. Although not illustrated, the RF unit 2429 may include, for example, a transceiver, a power amplifier module (PAM), a frequency filter, a low noise amplifier (LNA), and/or the like.

In addition, the RF module 2429 may further include a component for transmitting and receiving electromagnetic waves in a free space in a wireless communication, for example, a conductor, a conductive wire, or the like.

The memory 2430 may include an internal memory 2432 and an external memory 2434. The memory 2430 may be, for example, the memory 130 illustrated in FIG. 1. According to various embodiments of the present disclosure, internal memory 2432 may include, for example, at least one of a volatile memory (e.g., a dynamic random access memory (DRAM), a static RAM (SRAM), a synchronous DRAM (SDRAM), and/or the like), and a non-volatile memory (e.g., a one time programmable read-only memory (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, and/or the like). According to various embodiments of the present disclosure, the internal memory 2432 may be in the form of a solid state drive (SSD). The external memory 2434 may further include a flash drive, for example, a compact flash (CF), a secure digital (SD), a Micro-SD, a Mini-SD, an extreme digital (xD), a memory stick, and/or the like.

The sensor module 2440 may include, for example, at least one of a gesture sensor 2440A, a gyro sensor 2440B, an atmospheric pressure sensor 2440C, a magnetic sensor 2440D, an acceleration sensor 2440E, a grip sensor 2440F, a proximity sensor 2440G, a red, green and blue (RGB) sensor 2440H, a biometric sensor 24401, a temperature/humidity sensor 2440J, an illuminance sensor 2440K, and an ultraviolet (UV) sensor 2440M. The sensor module 2440 may measure a physical quantity and/or may detect an operating state of the electronic device 100, and may convert the measured or detected information to an electrical signal. Additionally/alternatively, the sensor module 2440 may include, for example, an E-nose sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and/or the like. Additionally or alternatively, the sensor module 2440 may include, for example, an E-nose sensor (not illustrated), an EMG sensor (not illustrated), an EEG sensor (not illustrated), an ECG sensor (not illustrated), a fingerprint sensor, and/or the like. The sensor module 2440 may further include a control circuit (not illustrated) for controlling one or more sensors included therein.

The input module 2450 may include a touch panel 2452, a pen sensor 2454 (e.g., a digital pen sensor), keys 2456, and an ultrasonic input unit 2458. The input module 2450 may be, for example, the user input module 140 illustrated in FIG. 1. The touch panel 2452 may recognize a touch input in at least one of, for example, a capacitive scheme, a resistive scheme, an infrared scheme, an acoustic wave scheme, and the like. In addition, the touch panel 2452 may further include a controller (not illustrated). In the capacitive type, the touch panel 2452 is capable of recognizing proximity as well as a direct touch. The touch panel 2452 may further include a tactile layer (not illustrated). In this event, the touch panel 2452 may provide a tactile response to the user.

The pen sensor 2454 (e.g., a digital pen sensor), for example, may be implemented by using a method identical or similar to a method of receiving a touch input from the user, or by using a separate sheet for recognition. For example, a key pad or a touch key may be used as the keys 2456.

The ultrasonic input unit 2458 enables the terminal to detect a sound wave by using a microphone (e.g., a microphone 2488) of the terminal through a pen generating an ultrasonic signal, and to identify data. The ultrasonic input unit 2458 is capable of wireless recognition. According to various embodiments of the present disclosure, the hardware 2400 may receive a user input from an external device (e.g., a network, a computer, a server, and/or the like), which is connected to the communication module 2430, through the communication module 2420.

The display module 2460 may include a panel 2462, a hologram 2464, a projector 2466, and/or the like. The display module 2460 may be, for example, the display module 150 illustrated in FIG. 1. The panel 2462 may be, for example, a liquid crystal display (LCD) and an active matrix organic light emitting diode (AM-OLED) display, and/or the like. The panel 2462 may be implemented so as to be, for example, flexible, transparent, or wearable. The panel 2462 may include the touch panel 2452 and one module. The hologram 2464 may display a three-dimensional image in the air by using interference of light. According to various embodiments of the present disclosure, the display module 2460 may further include a control circuit for controlling the panel 2462 or the hologram 2464.

The interface module 2470 may include an HDMI module 2472, a USB module 2474, an optical interface module 2476, a d-subminiature (D-SUB) module 2478, and/or the like. Additionally or alternatively, the interface 2470 may include, for example, one or more interfaces for SD/multimedia Card (MMC) (not shown) or infrared data association (IrDA) (not shown). The interface module 2470 or any of its sub-modules may be configured to interface with another electronic device (e.g., an external electronic device), an input device, an external storage device, and/or the like.

The audio module 2480 may encode/decode voice into electrical signal, and vice versa. The audio module 2480 may, for example, encode/decode voice information that are input into, or output from, a speaker 2482, a receiver 2484, an earphone 2486, and/or a microphone 2488.

The camera module 2491 may capture still images or video. According to various embodiments of the present disclosure, the camera module 2491 may include one or more image sensors (e.g., front sensor module or rear sensor module; not shown), an image signal processor (ISP, not shown), or a flash LED (not shown).

The power management module 2495 may manage electrical power of the hardware 2400. Although not shown, the power management module 2495 may include, for example, a power management integrated circuit (PMIC), a charger IC, a battery fuel gauge, and/or the like.

The PMIC, for example, may be disposed in an integrated circuit or an SoC semiconductor. The charging method for the hardware 2400 may include wired or wireless charging. The charger IC may charge a battery, or prevent excessive voltage or excessive current from a charger from entering the hardware 2400. According to various embodiments of the present disclosure, the charger IC may include at least one of a wired charger IC or a wireless charger IC. The wireless charger IC may be, for example, a magnetic resonance type, a magnetic induction type or an electromagnetic wave type, and may include circuits such as, for example, a coil loop, a resonance circuit or a rectifier.

The battery gauge may measure, for example, a charge level, a voltage while charging, a temperature of battery 2496, and/or the like. The battery 2496 may supply power to, for example, the hardware 2400. The battery 2496 may be, for example, a rechargeable battery.

The indicator 2497 may indicate one or more states (e.g., boot status, message status or charge status) of the hardware 2400 or a portion thereof (e.g., the AP 2411). The motor 2498 may convert electrical signal into mechanical vibration. MCU 2499 may control the sensor module 2440.

Although not illustrated, the hardware 2400 may include a processing unit (e.g., a GPU) for supporting a module TV. The processing unit for supporting a module TV may process media data according to standards such as, for example, digital multimedia broadcasting (DMB), digital video broadcasting (DVB), media flow, and/or the like.

Each of the above described elements of the electronic device according to various embodiments of the present disclosure may be formed of one or more components, and the name of a corresponding element may vary according to the type of an electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

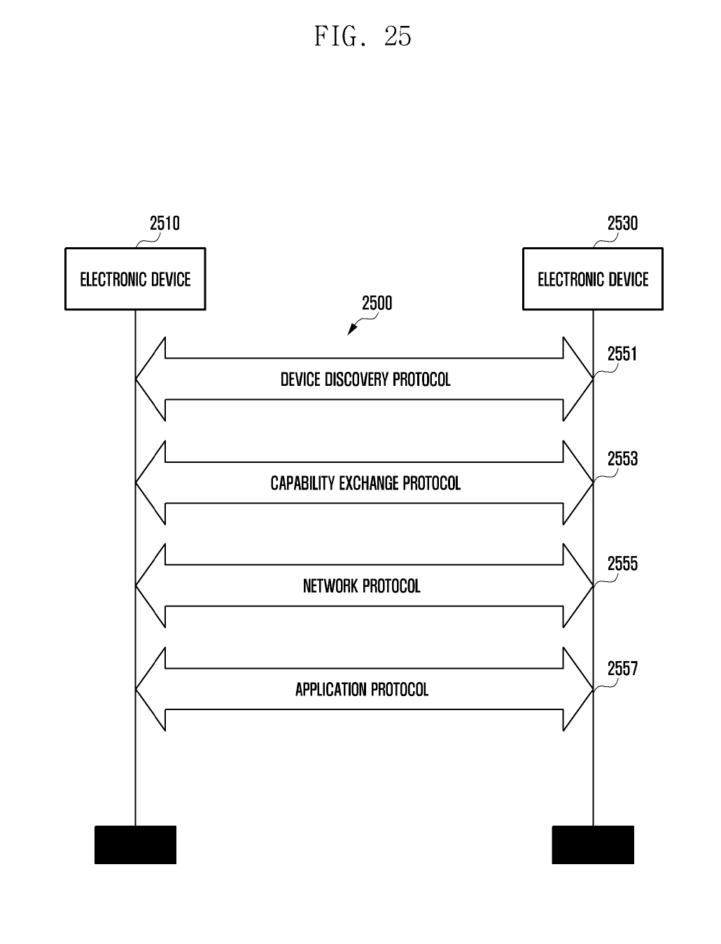

FIG. 25 illustrates a communication protocol between a plurality of electronic devices according to various embodiments of the present disclosure.

Referring to FIG. 25, a communication protocol 2510 between an electronic device 2510 and an electronic device 2530 according to various embodiments of the present disclosure is illustrated. The communication protocol 2500 may include a device discovery protocol 2551, a capability exchange protocol 2553, a network protocol 2555, and an application protocol 2557.

The device discovery protocol 2551 may allow the electronic devices (e.g., the electronic device 2510 or the electronic device 2530) to detect an external electronic device which can be connected thereto through short-range communication or connects the found external electronic device thereto. For example, the electronic device 2510 (e.g., the electronic device 100) may detect the electronic device 2530 (e.g., the electronic device 104) as a device, which can communicate with the electronic device 2510, through a short-range communication method (e.g., BT and/or the like) using the device discovery protocol 2551. The electronic device 2510 may acquire and store identification information of the electronic device 2530 detected through the device discovery protocol 2551 for a communication connection with the electronic device 2530. For example, the electronic device 2510 may establish the communication connection with the electronic device 2530 at least based on the identification information. The device discovery protocol 2551 may be a protocol for authenticating a plurality of electronic devices. For example, the electronic device 2510 may perform an authentication between the electronic device 2510 and the electronic device 2530 based on communication information (e.g., a media access control (MAC) address, a universally unique ID (UUID), a subsystem ID (SSID), and an information provider (IP) address) for the connection with the electronic device 2530.

The capability exchange protocol 2553 may be a protocol for exchanging information related to a service function which can be supported by at least one of the electronic device 2510 and the electronic device 2530. For example, the electronic device 2510 and the electronic device 2530 may exchange information related to a function currently provided by each of the electronic device 2510 and the electronic device 2530 through the capability exchange protocol 2553. The information which can be exchanged between the electronic devices may include identification information indicating a particular service which can be supported by the electronic device 2510 and the electronic device 2530. For example, the electronic device 2510 may receive, from the electronic device 2530, identification information of a particular service provided by the electronic device 2530 through the capability exchange protocol 2553. In this case, the electronic device 2510 may determine whether the electronic device 2510 can support the particular service based on the received identification information.

The network protocol 2555 controls flow of data which is transmitted/received to provide a service between the electronic devices (e.g., the electronic device 2510 and the electronic device 2530). For example, at least one of the electronic device 2510 and the electronic device 2530 may control an error or data quality by using the network protocol 2555. Additionally or alternatively, the network protocol 2555 may determine a transport format of data transmitted/received between the electronic device 2510 and the electronic device 2530. Further, at least one of the electronic device 2510 and the electronic device 2530 may at least manage a session (e.g., connect or terminate a session) for a data exchange between the electronic devices by using the network protocol 2555.

The application protocol 2557 may provide a process or information for exchanging data related to a service provided to an external electronic device. For example, the electronic device 2510 (e.g., the electronic device 100) may provide a service to the electronic device 2530 (e.g., the electronic device 104 or the server 106) through the application protocol 2557.

The communication protocol 2500 may include a standard communication protocol, a communication protocol designated by an individual or organization (e.g., a communication protocol self-designated by a communication device manufacturing company or a network supplying company) or a combination thereof.

The term “module” used in various embodiments of the present disclosure may refer to, for example, a “unit” including one of hardware, software, and firmware, or a combination of two or more thereof The term “module” may be interchangeable with a term such as a unit, a logic, a logical block, a component, or a circuit. The “module” may be a minimum unit of an integrated component or a part thereof. The “module” may be a minimum unit for performing one or more functions or a part thereof. The “module” may be mechanically or electronically implemented. For example, the “module” according to the present disclosure may include at least one of an application-specific IC (ASIC) chip, a field-programmable gate arrays (FPGA), and a programmable-logic device for performing operations which has been known or are to be developed hereinafter.

According to various embodiments of the present disclosure, at least some of the devices (e.g., modules or functions thereof) or the method (e.g., operations) according to the present disclosure may be implemented by a command stored in a non-transitory computer-readable storage medium in a programming module form. When the command is executed by one or more processors (e.g., the processor), the one or more processors may execute a function corresponding to the command. The non-transitory computer-readable storage medium may be, for example, the memory 130. At least a part of the programming module may be implemented (e.g., executed) by, for example, the processor 210. At least a part of the programming module may include, for example, a module, a program, a routine, a set of instructions, and/or a process for performing one or more functions.

The non-transitory computer-readable recording medium may include magnetic media such as a hard disk, a floppy disk, and a magnetic tape, optical media such as a Compact Disc ROM (CD-ROM) and a DVD, magneto-optical media such as a floptical disk, and hardware devices specially configured to store and perform a program instruction (e.g., programming module), such as a ROM, a RAM, a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

According to various embodiments of the present disclosure, a storage medium that stores commands is provided. The commands are configured to allow one or more processors to perform one or more operations when executed by the one or more processors. The one or more commands may include: displaying a first page among a plurality of pages and the GUI corresponding to the first page on a screen; displaying at least a part of the first page and at least a part of a second page adjacent to the first page among the plurality of pages based on a user input received in at least one of an area in which the first page is displayed and an area in which the GUI is displayed; and continuously changing the displayed GUI according to a ratio between an area of at least the part of the displayed first page and an area of at least the part of the displayed second page.

According to another example, the one or more commands may include: displaying one or more of a plurality of objects and the GUI corresponding to the one or more objects on a screen; scrolling the one or more objects based on a user input received in at least one of an area in which the one or more objects are displayed and an area in which the GUI is displayed; and continuously changing the GUI according to a scrolling distance of the one or more objects.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of displaying a graphic user interface (GUI) by an electronic device, the method comprising:
displaying a first page from a plurality of pages and the GUI corresponding to the first page on a screen;
displaying at least a part of the first page and at least a part of a second page adjacent to the first page from the plurality of pages based on a user input received in at least one of an area in which the first page is displayed and an area in which the GUI is displayed; and
changing the displayed GUI according to a ratio between an area of at least the part of the displayed first page and an area of at least the part of the displayed second page.

2. The method of claim 1, wherein the GUI includes page indicators.

3. The method of claim 2, wherein the changing of the displayed GUI comprises changing at least one of a size, slope, color, color depth, thickness, and area of the page indicator.

4. The method of claim 2, further comprising:
inserting a third page or removing the first page; and
when the third page is inserted or the first page is removed, changing the page indicator.

5. The method of claim 2, wherein the changing of the displayed GUI further comprises changing the page indicator based on at least one of a speed, intensity, and pressure of the received user input.

6. The method of claim 2, further comprising:
increasing or decreasing an area of the first page in a state where the first page is displayed in the middle of the screen; and
when the area of the first page is increased or decreased, changing the page indicator.

7. The method of claim 2, wherein the changing of the displayed GUI further comprises changing the page indicator in a different way according to a page switching type.

8. The method of claim 2, wherein the changing of the displayed GUI further comprises, when the user input is received, moving the page indicator displayed in the area to another area and displaying the page indicator in the moved area.

9. The method of claim 2, wherein the page indicator is differently displayed according to a characteristic of an object included in each of the plurality of pages.

10. The method of claim 1, wherein the electronic device further comprises one or more screens, and the screen and the one or more screens display the first page and the GUI, respectively.

11. The method of claim 1, wherein the screen and a screen of another electronic device display the first page and the GUI through an interworking with the other electronic device.

12. An electronic device comprising:
a display;
a user input device; and
a processor configured to:
display a first page from a plurality of pages and a graphic user interface (GUI) corresponding to the first page on a screen,
display at least a part of the first page and at least a part of a second page adjacent to the first page from the plurality of pages based on a user input received in at least one of an area in which the first page is displayed and an area in which the GUI is displayed, and
change the displayed GUI according to a ratio between an area of at least the part of the displayed first page and an area of at least the part of the displayed second page.

13. The electronic device of claim 12, wherein the GUI includes page indicators.

14. The electronic device of claim 13, wherein the processor is further configured to controls the display to change at least one of a size, slope, color, color depth, thickness, and area of the page indicator.

15. The electronic device of claim 13, wherein the processor is further configured to:
insert a third page or removes the first page, and control the display to change the page indicator when the third page is inserted or the first page is removed.

16. The electronic device of claim 13, wherein the processor is further configured to control the display to change the page indicator based on at least one of a speed, intensity, and pressure of the received user input.

17. The electronic device of claim 13, wherein the processor is further configured to increase or decrease an area of the first page in a state where the first page is displayed in the middle of the screen, and controls the display to change the page indicator when the area of the first page is increased or decreased.

18. The electronic device of claim 13, wherein the processor is further configured to control the display to change the page indicator in a different way according to a page switching type.

19. The electronic device of claim 13, wherein, when the user input is received, the processor moves the page indicator displayed in the area to another area and displays the page indicator in the moved area.

20. The electronic device of claim 13, wherein the processor is further configured to control the display to differently display the page indicator according to a characteristic of an object included in each of the plurality of pages.

21. A computer-readable recording medium having a program recorded therein to execute commands, the commands comprising:
displaying a first page from a plurality of pages and the graphic user interface (GUI) corresponding to the first page on a screen;
displaying at least a part of the first page and at least a part of a second page adjacent to the first page from the plurality of pages based on a user input received in at least one of an area in which the first page is displayed and an area in which the GUI is displayed; and
changing the displayed GUI according to a ratio between an area of at least the part of the displayed first page and an area of at least the part of the displayed second page.
